(19) United States
(12) Patent Application Publication
(10) Pub. No.: US 2026/0177817 A1
(43) Pub. Date: Jun. 25, 2026

(54) DISPLAY DEVICE AND DISPLAY DEVICE MODULE

(71) Applicant: SONY GROUP CORPORATION, TOKYO (JP)

(72) Inventors: MAMORU SUZUKI, TOKYO (JP); TAKATOSHI MATSUYAMA, TOKYO (JP); SUSUMU ICHIKAWA, TOKYO (JP); MASATOSHI NAKAMURA, TOKYO (JP); TOMOYOSHI KURODA, TOKYO (JP)

(21) Appl. No.: 18/856,245

(22) PCT Filed: Apr. 5, 2023
(86) PCT No.: PCT/JP2023/014025

§ 371 Date: Oct. 11, 2024

(30) Foreign Application Priority Data
Apr. 19, 2022 (JP) 2022-068676

(51) Int. Cl. G02B 27/01; F21V 8/00; G09G 3/00

(52) U.S. Cl. CPC G02B 27/0101; G02B 6/0055; G02B 27/0172; G09G 3/003; G02B 2027/0127

(57) ABSTRACT

An object of the present disclosure is to provide a technique for enhancing reality of an image or reducing discomfort caused by the image. The present disclosure provides a display device including at least: a first display element and a second display element; an optical element that transmits first display light emitted from the first display element and reflects second display light emitted from the second display element to form superimposed display light; and a light guide optical system that guides the superimposed display light to an eyeball. The light guide optical system is configured to form an intermediate image at least once on an optical path between the eyeball and each of the display elements. The display device may be configured to make either or both of the position of a virtual image plane formed by the first display light and the position of a virtual image plane formed by the second display light shiftable, for example.

### TECHNICAL FIELD

The present disclosure relates to a display device and a display device module.

### BACKGROUND ART

One type of device for displaying images includes a display device including a right-eye module and a left-eye module. Such a display device is configured as, for example, a stationary display device or a head-mounted display device (also referred to as head-mounted display or HMD). Such a display device has been used in various scenes.

Such a display device may be configured to provide a virtual image to a user, i.e., to form the virtual image on the retina of each eye. In order to improve images presented to the user by the display device, various techniques have been proposed.

For example, the following Patent Document 1 discloses an invention that is aimed at providing an excellent HMD that is used with being mounted on the head of a user and can provide a suitable virtual image, specifically an excellent HMD that can provide a virtual image that gives the user a realistic feeling as if the user watches a film at the best seat in a movie theater. The HMD disclosed in Patent Document 1 “including: a left-eye display panel that displays a left-eye image; a left-eye optical system that has an angle of view from 45 to 55 degrees and forms a virtual image of the left-eye image; a right-eye display panel that displays a right-eye image; a right-eye optical system that has an angle of view from 45 to 55 degrees and forms a virtual image of the right-eye image; and a display control unit that controls the screen display of the left-eye display panel and the right-eye display panel” (claim 1).

Furthermore, the following Patent Document 2 discloses an invention relating to aberration correction. The Patent Document 2 discloses an invention relating to a display apparatus including an eyepiece display unit including an image display device and an eyepiece optical system that guides a display image displayed on the image display device to an eye point. In the display apparatus, “an image magnification by the eyepiece optical system being twice or more, the eyepiece optical system including a coaxial system including a plurality of single lenses, at least one of the plurality of single lenses including an aspherical lens including a resin material, and the image display device displaying, as the display image, an image for correction of distortion and chromatic aberration of magnification generated in the eyepiece optical system” (claim 1).

### CITATION LIST

### Patent Document

Patent Document 1: Japanese Patent Application Laid-Open No. 2012-141461

Patent Document 2: Japanese Patent Application Laid-Open No. 2020-020935

### SUMMARY OF THE INVENTION

### Problems to be Solved by the Invention

A virtual image plane generated by the optical system of the display device described above generally includes only one plane. For example, in a case where the virtual image plane generated by the display device includes one plane for an image or the like capturing an object of interest to which the user is paying attention and a background of the object, the object of interest and the background, however, are arranged at the same distance. In this case, the image diverges from perceived images that the user experiences on a daily basis. The divergence is also called vergence-accommodation conflict. The divergence may reduce the reality of the image or may cause discomfort to the user.

It is therefore an object of the present disclosure to provide a technique for reducing divergence and enhancing the reality of an image or reducing discomfort caused by the image.

### Solutions to Problems

The present disclosure provides a display device including at least:
a first display element and a second display element;
an optical element that transmits first display light emitted from the first display element and reflects second display light emitted from the second display element to form superimposed display light; and
a light guide optical system that guides the superimposed display light to an eyeball, in which
the light guide optical system is configured to form an intermediate image at least once on an optical path between the eyeball and each of the display elements.

The display device may be configured to make either or both of the position of a virtual image plane formed by the first display light and the position of a virtual image plane formed by the second display light shiftable.

At least one of the first display element or the second display element may be configured to be shiftable in an optical axis direction, and be configured to shift the position of the virtual image plane formed by each ray of display light in response to a shift in the optical axis direction.

In the display device, two sets of display device modules each including the first display element, the second display element, the optical element, and the light guide optical system may be provided, and
one of the two sets of display device modules may be configured to cause the superimposed display light to reach a left eye, and the other of the two sets of display device modules may be configured to cause the superimposed display light to reach the left eye.

The display device may be configured to present, using two or more rays of display light, one image higher in resolution than each ray of display light.

The display device may further include a reflective element that reflects the superimposed display light to cause the superimposed display light to travel toward the eyeball.

The optical element and the reflective element may be arranged so as to make a virtual image distance distribution in an observation plane approximately symmetrical in a left-right direction.

The first display element may be arranged so as to cause a display surface of the first display element to tilt relative to a plane orthogonal to an optical axis of the first display light.

An antireflection film may be provided on a surface on which the first display light emitted from the first display element impinges, of two surfaces of the optical element.

A metal film may be provided on a surface on which the second display light emitted from the second display element impinges, of two surfaces of the optical element.

No optical component may be arranged at or near a position where the intermediate image is formed.

The light guide optical system may include a lens optical system arranged on an optical path between the first display element and the optical element and a lens optical system arranged on an optical path between the second display element and the optical element, and

the two lens optical systems may have the same configuration.

The display device may be configured to correct an image displayed by each of the display elements in accordance with two or more rays of display light to be superimposed.

The display device may further include a reflective element that reflects the superimposed display light to cause the superimposed display light to travel toward the eyeball, the reflective element being configured not to transmit light.

The display device may be configured as a stationary display device.

A display surface of the first display element and a display surface of the second display element may each have a diagonal dimension of 5 inches or less.

The display device may have a viewing angle of 70°or more.

The display device may have an image magnification of 1.5 times or more.

Furthermore, the present disclosure further provides a display device module including at least:
a first display element and a second display element;
an optical element that transmits first display light emitted from the first display element and reflects second display light emitted from the second display element to form superimposed display light; and
a light guide optical system that guides the superimposed display light to an eyeball, in which
the light guide optical system is configured to form an intermediate image at least once on an optical path between the eyeball and each of the display elements.

### BRIEF DESCRIPTION OF DRAWINGS

FIG. 1 is a diagram illustrating an example of an optical system for generating a plurality of virtual image planes.

FIG. 2 is a diagram schematically illustrating a configuration example of a display device of the present disclosure.

FIG. 3 is a diagram schematically illustrating a configuration example of the display device of the present disclosure.

FIG. 4A is a diagram schematically illustrating a configuration example of the display device of the present disclosure.

FIG. 4B is a diagram schematically illustrating a configuration example of the display device of the present disclosure.

FIG. 5 is a diagram schematically illustrating an example of an optical path in a case where an intermediate image is formed once.

FIG. 6 is a schematic diagram for describing how a display element is shifted.

FIG. 7 is a diagram for describing an example of an image presented by the display device of the present disclosure.

FIG. 8 is a diagram for describing a rotation angle of a reflective element.

FIG. 9A is a diagram for describing the rotation angle of the reflective element.

FIG. 9B is a diagram for describing the rotation angle of the reflective element.

FIG. 10 is a schematic diagram for describing an angle of incident of light on an optical element.

FIG. 11 is a diagram showing analysis results of virtual image distance distribution.

FIG. 12 is a schematic diagram for describing the behavior of light between two reflective elements.

FIG. 13A is a schematic diagram for describing a tilt δ.

FIG. 13B is a schematic diagram for describing the tilt δ.

FIG. 14 is a diagram showing analysis results of virtual image distance distribution.

FIG. 15 is a diagram schematically illustrating an example of stray light that forms a double image.

FIG. 16 is a diagram illustrating an example of the double image.

FIG. 17 is a schematic diagram for describing a position where an intermediate image is formed.

FIG. 18 is a diagram showing analysis results of a visible image.

FIG. 19 is a diagram illustrating a schematic example of image correction.

FIG. 20 is a schematic diagram for describing how positions of lenses overlap.

FIG. 21 is a diagram schematically illustrating a configuration example of a display device including an imaging element.

FIG. 22 is a diagram schematically illustrating an example of a display device in which two virtual image planes are formed.

FIG. 23 is a diagram schematically illustrating an example of a display device in which four virtual image planes are formed.

FIG. 24 is a diagram schematically illustrating an example of a display device in which eight virtual image planes are formed.

FIG. 25 is a diagram for describing enhancement of resolution through superimposition of display light.

FIG. 26A is a diagram illustrating an example of the appearance of the display device.

FIG. 26B is a diagram illustrating an example of how the display device is used.

FIG. 27 is a block diagram of a configuration example of the display device of the present disclosure.

FIG. 28 is a diagram for describing enhancement of image quality by providing a metal film on an optical element.

### MODE FOR CARRYING OUT THE INVENTION

Hereinafter, preferred modes for carrying out the present disclosure will be described. Note that the embodiments described below show typical embodiments of the present disclosure, and the scope of the present disclosure is not limited only to these embodiments.

The present disclosure will be described in the following order.
1. Description of present disclosure
2. First embodiment (display device)
(1) Configuration example
(2) Shift of display element
(3) Arrangement of reflective element and optical element
(4) Tilt of first display element
(5) AR coating
(6) Metal film
(7) No lens is arranged at or near position where intermediate image is formed
(8) Shape of lens optical system
(9) Image correction
(10) Reflective element that does not transmit light
(11) Modification
(11-1: Adjustment to virtual image distance)
(11-2: Varifocal lens)
(11-3: Imaging element)
(11-4: Increase in number of virtual image planes)
(11-5: Resolution enhancement)
3. Second embodiment (display device module)

### 1. Description of Present Disclosure

As described above, in a case where the virtual image plane generated by the display device includes one plane, the image generated by the display device may diverge from the perceived image that the user experiences on a daily basis. The divergence may reduce the reality of the image or may cause discomfort to the user.

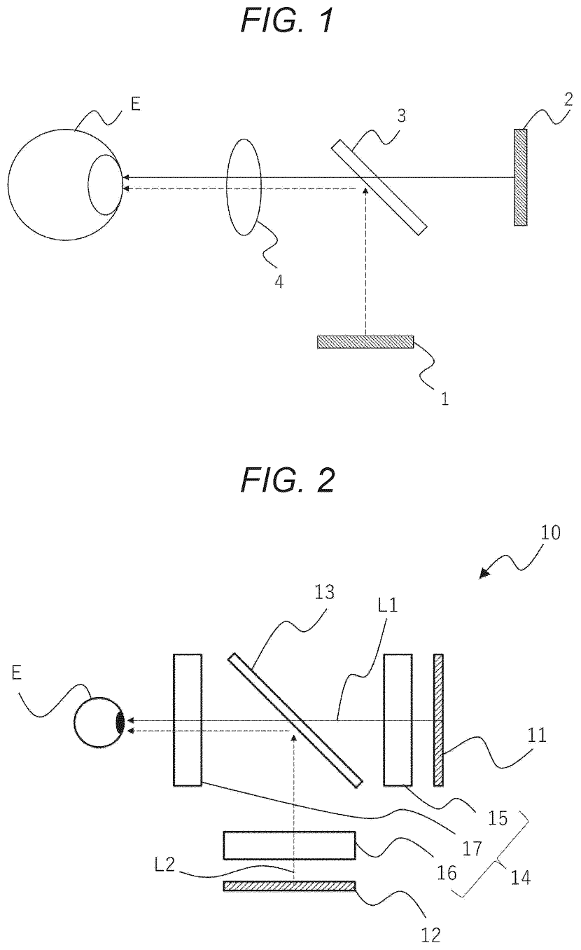

It is therefore conceivable that the optical system of the display device is configured to form a plurality of virtual image planes. In order to generate a plurality of virtual image planes, for example, as illustrated in FIG. 1, it is conceivable that the optical system is configured to superimpose rays of image display light emitted from two display elements 1 and 2 using an optical element 3 such as a half mirror or a beam splitter. Furthermore, in order to make the virtual image visible to the user at a desired image magnification, a lens 4 may be arranged between the optical element 3 and an eyeball. The plurality of virtual image planes can be formed by the respective rays of image display light emitted from the display elements 1 and 2 that are superimposed so as to make their respective virtual image distances different from each other. That is, it is possible to generate a plurality of virtual images different in position in a depth direction (optical axis direction of the image display light entering the eyeball).

In order to employ the configuration as illustrated in FIG. 1, it is necessary to provide the optical element 3 such as a half mirror or a beam splitter on the optical path of the image display light. In order to provide the optical element 3 on the optical path, a space for arranging the optical element needs to be provided between the lens 4 and the display elements 1 and 2. Providing such a space is relatively easy for an optical system having a relatively low image magnification (that is, an optical system having a relatively long focal length) and a small number of lenses (for example, including only one or two lenses).

It is, however, difficult in many cases to provide the space for, for example, an optical system having a high image magnification, such as an optical system including a small display element of about 1 inch and having a viewing angle exceeding 100°.

One of the reasons for the difficulty is that, for example, the focal length is relatively short in the optical system having a high image magnification.

Furthermore, another reason is that it is necessary for such an optical system to provide a plurality of lenses on the optical path for aberration correction, and the number of lenses is increased accordingly (for example, three or more lenses). For example, as described in Patent Document 2, three or more lenses are used to form one lens optical system for aberration correction.

As described above, it is difficult for a wide-angle display device using a small display element to generate a plurality of virtual image planes.

A display device of the present disclosure includes at least a first display element and a second display element, an optical element that transmits first display light emitted from the first display element and reflects second display light emitted from the second display element to form superimposed display light, and a light guide optical system that guides the superimposed display light to an eyeball. Here, the light guide optical system is configured to form an intermediate image at least once on an optical path between the eyeball and each display element.

In the display device, since the respective rays of display light emitted from the at least two display elements included in the display device are superimposed, a plurality of virtual image planes can be formed. It is therefore possible to reduce divergence in the perceived image described above. Moreover, since the light guide optical system is configured to form an intermediate image at least once, it is easy to arrange the optical element for the superimposition. Furthermore, in addition to the optical element for the superimposition, an optical component for light guide can be arranged, and various improvements can be made as described later in image presentation by a plurality of virtual image planes. Furthermore, the optical system that forms an intermediate image has a space large enough for the lens to be arranged, and aberration correction can be easily performed, and optical performance can be improved as compared with an optical system that does not form an intermediate image.

In one embodiment, the display device may be configured to make either or both of the position of a virtual image plane formed by the first display light and the position of a virtual image plane formed by the second display light shiftable. It is therefore possible to increase the reality of the image. The shift of the position of the virtual image plane may be performed by, for example, shifting the first display element and the second display element in the optical axis direction, but may be performed by another method.

As such, the present disclosure enables an adjustment to the virtual image distance, but the present disclosure may be used for other purposes. For example, the position of the virtual image plane may be adjusted for diopter correction.

### 2. First Embodiment (Display Device)

### (1) Configuration Example

A configuration example of the display device of the present disclosure will be described with reference to FIG. 2.

In the drawing, an example of a schematic arrangement of components included in the display device according to the present disclosure is illustrated. A display device 10 in the drawing includes a first display element 11, a second display element 12, and an optical element 13 that transmits first display light L1 emitted from the first display element and reflects second display light L2 emitted from the second display element to form superimposed display light.

The display device 10 further includes a light guide optical system 14. The light guide optical system includes a lens optical system 15 provided on an optical path between the first display element 11 and the optical element 13, a lens optical system 16 provided on an optical path between the second display element 12 and the optical element 13, and a lens optical system 17 provided on an optical path between the optical element 13 and an eyeball E. The light guide optical system is configured to form an intermediate image at least once (for example, once, twice, or three times, preferably once or twice, more preferably once) on the optical path between the eyeball and each display element. More specifically, the light guide optical system is configured to form an intermediate image at least once (for example, once, twice, or three times, preferably once or twice, more preferably once) on the optical path between the eyeball and the optical element 13.

The first display element 11, the second display element 12, the optical element 13, and the light guide optical system 14 described above may be configured as one set of display device modules for presenting image display light to one eyeball. That is, the display device according to the present disclosure may include the display device module for the left eye and the display device module for the right eye. That is, the display device according to the present disclosure may include two display device modules each including the first display element 11, the second display element 12, the optical element 13, and the light guide optical system 14.

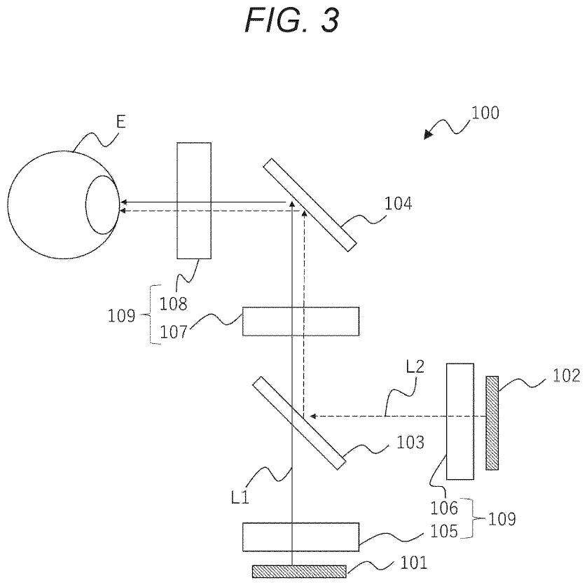

A more specific example of the display device configured as described above will be described with reference to FIG. 3.

FIG. 3 illustrates a more specific configuration example of the display device according to the present disclosure.

A display device 100 in the drawing includes a first display element 101, a second display element 102, and an optical element 103 that transmits first display light emitted from the first display element and reflects second display light emitted from the second display element to form superimposed display light.

More specifically, the optical element 103 transmits the first display light to cause the first display light to reach a reflective element 104. Furthermore, the optical element 103 reflects the second display light to cause the second display light to reach the reflective element 104. The optical element 103 superimposes the first display light and the second display light by means of the transmission and the reflection to form superimposed display light, and then causes the superimposed display light to reach the reflective element 104.

The display device 100 further includes the reflective element 104 that reflects the superimposed display light (that is, both the first display light and the second display light). The reflective element reflects the superimposed display light to cause the superimposed display light to travel the eyeball E.

The display device 100 further includes a light guide optical system 109. The light guide optical system may include at least the following four lens optical systems:
A lens optical system 105 provided on an optical path between the first display element 101 and the optical element 103;
A lens optical system 106 provided on an optical path between the second display element 102 and the optical element 103;
A lens optical system 107 provided on an optical path between the optical element 103 and the reflective element 104; and
A lens optical system 108 provided on an optical path between the reflective element 104 and the eyeball E.

The light guide optical system is configured to form an intermediate image at least once (for example, once, twice, or three times, preferably once or twice, more preferably once) on the optical path between the eyeball and each display element.

More specifically, the light guide optical system is configured to form an intermediate image at least once (for example, once, twice, or three times, preferably once or twice, more preferably once) on the optical path between the eyeball E and the optical element 103.

Moreover, the light guide optical system is configured to form an intermediate image at least once (for example, once, twice, or three times, preferably once or twice, more preferably once) more specifically on the optical path between the eyeball E and the reflective element 104.

The light guide optical system may be configured to guide the first display light and the second display light to the optical element 103 and guide the superimposed display light to the eyeball E.

Furthermore, the light guide optical system may be configured to cause the first display light L1 emitted from the first display element 101 and the second display light L2 emitted from the second display element 102 to each form an intermediate image at least once.

The lens optical systems 105, 107, and 108 are arranged on the optical path of the first display light L1. The lens optical systems located on the optical path are configured to cause the first display light L1 to form an intermediate image at least once on the optical path between the first display element 101 and the eyeball E.

Furthermore, the lens optical systems 106, 107, and 108 are arranged on the optical path of the second display light L2. The lens optical systems located on the optical path are configured to cause the second display light L2 to form an intermediate image at least once on the optical path between the second display element 101 and the eyeball E.

The light guide optical system (specifically, each lens optical system constituting the light guide optical system) is configured to form an intermediate image at least once as described above. As described above, the configuration of the lens group included in the light guide optical system (each lens optical system) for forming an intermediate image at least once may be designed as appropriate by a person skilled in the art.

The first display element 101, the second display element 102, the optical element 103, the reflective element 104, and the light guide optical system 109 (the lens optical systems 105 to 108) described above may be configured as one set of display device modules for presenting image display light to one eyeball. The display device according to the present disclosure may include the display device module for the left eye and the display device module for the right eye. That is, the display device according to the present disclosure may include two sets of display device modules each including the first display element 101, the second display element 102, the optical element 103, the reflective element 104, and the light guide optical system (the lens optical systems 105 to 108). One of the two sets of display device modules may be configured to cause the superimposed display light to reach the left eye, and the other may be configured to cause the superimposed display light to reach the left eye.

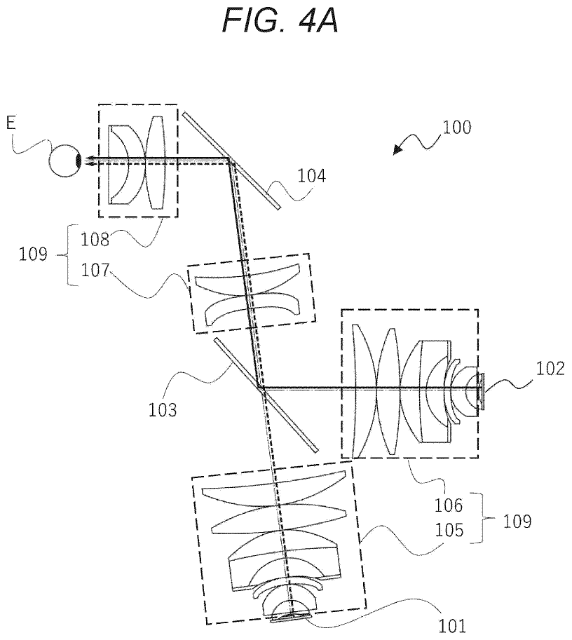

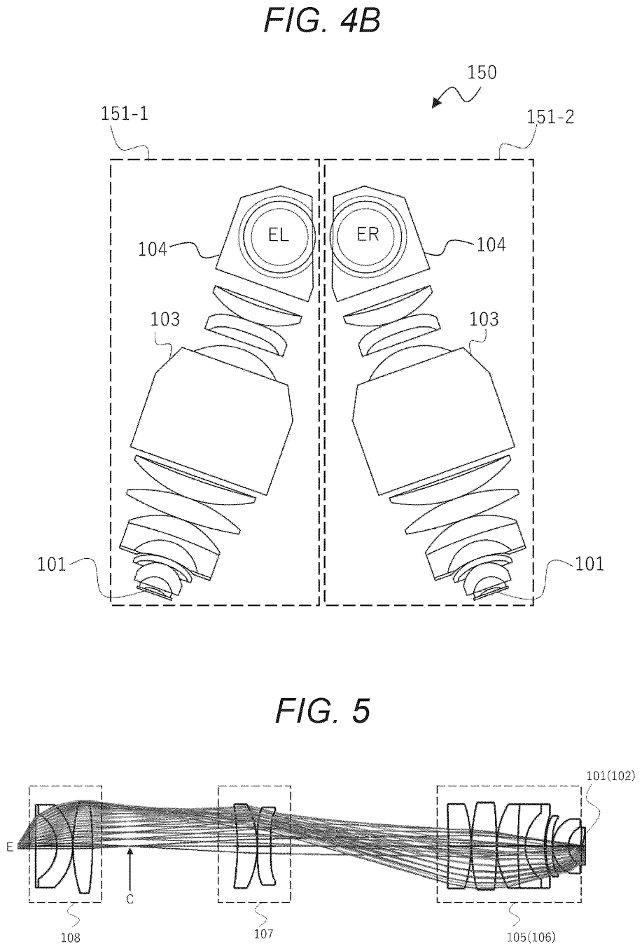

For the display device illustrated in FIG. 3, a configuration example of each lens optical system and a schematic example of how to form an intermediate image will be described with reference to FIGS. 4A and 4B and FIG. 5.

FIG. 4A illustrates a configuration example of the display device according to the present disclosure including a configuration example of the lens group included in each lens optical system. A display device 100 illustrated in the drawing includes, as with the display device illustrated in FIG. 3, a first display element 101, a second display element 102, an optical element 103, a reflective element 104, and a light guide optical system 109 (lens optical systems 105 to 108).

Among these, the first display element 101, the second display element 102, the optical element 103, and the reflective element 104 are as described above with reference to FIG. 3, and the description also applies to the display device 100 illustrated in FIG. 4A.

Furthermore, as described above, the first display element 101, the second display element 102, the optical element 103, the reflective element 104, and the light guide optical system 109 illustrated in FIG. 4A may be configured as one set of display device modules for presenting image display light to one eyeball. Therefore, the display device according to the present disclosure may include two sets of the display device modules. FIG. 4B illustrates a configuration example of the display device as described above in a direction from a face side of the user wearing the display device toward a device side.

A display device 150 illustrated in FIG. 4B includes display device modules 151-1 and 151-2. The display device module 151-1 is for the left eye, and the display device module 151-2 is for the right eye. The two modules may be configured in the same manner, but are arranged so as to be bilaterally symmetrical.

In the drawing, the left eye is at the position indicated by EL, and the right eye is at the position indicated by ER. In the left-eye module 151-1, the first display element 101 is arranged below the left eye. The first display light emitted from the first display element 101 is transmitted through the optical element 103 and reaches the reflective element 104. Furthermore, although not illustrated in the drawing, the second display element 102 is located at a position coincident with the optical element 103, that is, arranged below the left eye. The second display light emitted from the second display element 102 is reflected by the optical element 103 and reaches the reflective element 104. The first display light and the second display light are superimposed by the optical element 103, and the superimposed display light obtained by the superimposition of the first display light and the second display light reaches the reflective element 104. The reflective element 104 reflects the superimposed display light to cause the superimposed display light to reach the left eye.

Also in the right-eye module 151-2, the first display element 101 is arranged below the left eye. The second display element 102 is also arranged below the right eye. The superimposed display light is caused to reach the right eye in a similar manner.

In the present disclosure, each module may be provided such that the display elements 101 and 102 included in the module are located below the corresponding eye, and accordingly, the optical element 103 is also located below the eye. Furthermore, the reflective element 104 may be provided at a position where the reflective element 104 can cause, by reflection, the superimposed display light to reach the eye. Such an arrangement of the components is merely an example, and may be changed as appropriate by a person skilled in the art.

Next, the lens optical systems 105 to 108 included in the light guide optical system will be described below.

The lens optical systems 105, 107, and 108 are configured to cause the first display light L1 emitted from the first display element 101 to form an intermediate image at least once on the optical path between the eyeball E and the first display element 101. FIG. 5 is a diagram schematically illustrating an example of the optical path in a case where an intermediate image is formed once on the optical path.

As illustrated in the drawing, the first display light L1 emitted from the first display element 101 forms an intermediate image on the optical path between the lens optical system 107 and the lens optical system 108. Then, after the formation of the intermediate image, the lens optical system 108 causes the first display light L1 to form an image again on the retina of the eyeball.

That is, the lens optical systems 105, 107, and 108 are configured to cause the first display light L1 to form an intermediate image on the optical path between the lens optical system 107 and the lens optical system 108 as described above. Moreover, the lens optical systems 105, 107, and 108 are configured to cause the first display light L1 to form an image again on the retina of the eyeball after the formation of the intermediate image.

The configuration of each lens optical system for forming an intermediate image and a virtual image plane as described above can be designed as appropriate by a person skilled in the art. An example of the configuration of each lens optical system will be described with reference to FIG. 5.

First, the lens optical systems 105, 107, and 108 that guide the first display light L1 from the first display element 101 will be described.

The lens optical system 105 and the lens optical system 107 are configured to cause the first display light L1 to form an image at a position C (specifically, form an intermediate image). Moreover, the lens optical system 108 is configured to cause the first display light L1 that has formed the intermediate image at the position C to form an image on the eyeball. With this configuration, a virtual image plane is formed.

As illustrated in the drawing, the lens optical system 105 may include a plurality of lenses, or may include one lens. The lens optical system 105 has a configuration where a meniscus lens, a meniscus lens, a triplet lens (achromatic triplet), a biconvex lens, and a convex meniscus lens are arranged in this order along the direction in which the first display light L1 travels from the emission surface of the first display element 101, but this configuration is merely an example, and a configuration may be selected as appropriate by a person skilled in the art in accordance with, for example, the configuration of the optical path and aberration to be corrected. For example, the lens optical system 105 may include, for example, at least one achromatic lens. The lens optical system 105 may further include one or more meniscus lenses (one or more convex meniscus lenses and/or one or more concave meniscus lenses). The lens optical system 105 may further include one or more biconvex lenses and/or one or more plano-convex lenses.

The total number of lenses included in the lens optical system 105 may be, for example, 1 to 10, preferably 2 to 8, and more preferably 3 to 7.

Furthermore, the lens optical system 105 may preferably include one or more aspheric lenses (for example, one aspheric lens, two aspheric lenses, three aspheric lenses, or the like). In the present disclosure, the aspherical lens is preferably used.

As illustrated in the drawing, the lens optical system 107 may include a plurality of lenses, or may include one lens. The lens optical system 107 has a meniscus lens and a convex meniscus lens arranged in this order along the direction in which the first display light L1 travels from the emission surface of the first display element 101, but this configuration is merely an example, and a configuration may be selected as appropriate by a person skilled in the art in accordance with, for example, the configuration of the optical path and aberration to be corrected. For example, the lens optical system 107 may further include one or more meniscus lenses (one or more convex meniscus lenses and/or one or more concave meniscus lenses). Additionally or alternatively, the lens optical system 107 may include one or more biconvex lenses and/or one or more plano-convex lenses.

The total number of lenses included in the lens optical system 107 may be, for example, 1 to 6, preferably 2 to 5, and more preferably 2 to 4.

Furthermore, the lens optical system 107 may preferably include one or more aspherical lenses (for example, one aspherical lens, two aspherical lenses, three aspherical lenses, or the like). In the present disclosure, the aspherical lens is preferably used.

As illustrated in the drawing, the lens optical system 108 may include a plurality of lenses, or may include one lens. The lens optical system 108 has a biconvex lenses and a meniscus lens arranged in this order along the direction in which the first display light L1 travels from the emission surface of the first display element 101, but this configuration is merely an example, and a configuration may be selected as appropriate by a person skilled in the art in accordance with, for example, the configuration of the optical path and aberration to be corrected. For example, the lens optical system 108 may further include one or more biconvex lenses and/or one or more plano-convex lenses. The lens optical system 108 may further include, for example, one or more meniscus lenses (one or more convex meniscus lenses and/or one or more concave meniscus lenses).

The total number of lenses included in the lens optical system 108 may be, for example, 1 to 6, preferably 2 to 5, and more preferably 2 to 4.

Furthermore, the lens optical systems 106, 107, and 108 are configured to cause the second display light L2 emitted from the second display element 102 to form an intermediate image at least once on the optical path between the eyeball E and the second display element 102. A diagram schematically illustrating a path in a case where the intermediate image is formed at least once on the optical path is similar to FIG. 5 referred to above.

That is, the lens optical system 106 may be configured in the same manner as the lens optical system 105, and the description of the lens optical system 105 also applies to the lens optical system 106.

As illustrated in the drawing, the second display light L2 emitted from the second display element 102 forms an intermediate image on the optical path between the lens optical system 107 and the lens optical system 108. Then, after the formation of the intermediate image, the lens optical system 108 causes the second display light L2 to form an image again on the retina of the eyeball.

That is, the lens optical systems 106, 107, and 108 are configured to cause the second display light L2 to form an intermediate image on the optical path between the lens optical system 107 and the lens optical system 108 as described above. Moreover, the lens optical systems 106, 107, and 108 are configured to cause the second display light L2 to form an image again on the eyeball after the formation of the intermediate image.

As described above, the display device according to the present disclosure may be configured to cause any of the two or more rays of display light superimposed by the optical elements to form an intermediate image on the optical path between each display element and the eyeball. The light guide optical system (each lens optical system) for forming an intermediate image as described above may be configured as described above, for example, but the configuration of the light guide optical system is not limited to such a configuration, and may be designed as appropriate by a person skilled in the art.

For example, for the purpose of adjusting the traveling direction of the display light or the like, the display device of the present disclosure may further include one or more other reflective elements and/or one or more other superimposing optical elements in addition to the superimposing optical element and the reflective element. In the present disclosure, the other reflective element and the other superimposing optical element may be arranged so as to satisfy a condition regarding an arrangement to be described later, but may be arranged so as not to satisfy such a condition.

In one embodiment, the display element (for example, the first display element and the second display element, and the other display element to be described below) included in the display device according to the present disclosure may be a small display element having a size of about 1 inch. In a case where such a small display element is included in the display device, the effect of the present disclosure is particularly remarkably exhibited. The size of the display element means a diagonal dimension of a display surface of the display element.

Each display element included in the display device according to the present disclosure may have a size of, for example, 0.1 inches or more, preferably 0.2 inches or more, more preferably 0.3 inches or more, 0.4 inches or more, or 0.5 inches or more.

Furthermore, each display element may have a size of, for example, 5 inches or less, preferably 4 inches or less, and more preferably 3 inches or less.

In one embodiment, the display device according to the present disclosure may have a viewing angle of, for example, 70° or more, preferably 80° or more, and more preferably 100° or more.

An upper limit value of the viewing angle need not be set, but the viewing angle may be, for example, 150° or less, 140° or less, or 130° or less.

The light guide optical system of the display device according to the present disclosure may be configured to set the viewing angle within such a numerical range. The present disclosure is particularly suitable for a display device having such a wide viewing angle.

In one embodiment, the display device according to the present disclosure may be configured as a stationary display device.

Furthermore, in another embodiment, the display device according to the present disclosure may be configured as a head-mounted display device.

Such display devices may each include the left-eye module and the right-eye module as described above.

Furthermore, the display device according to the present disclosure may be configured as a device for presenting images to a user, may be configured as, for example, a display device for presenting virtual reality (VR) or augmented reality (AR) to a user, and may be preferably configured as a display device for VR presentation.

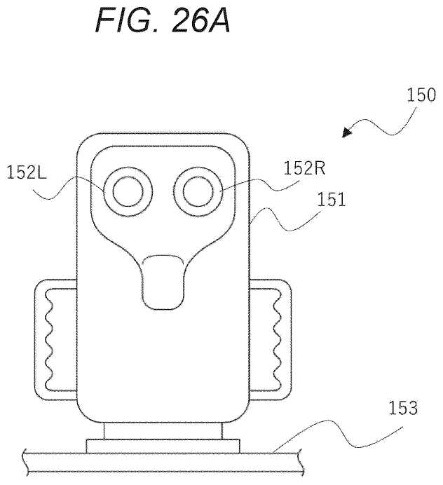

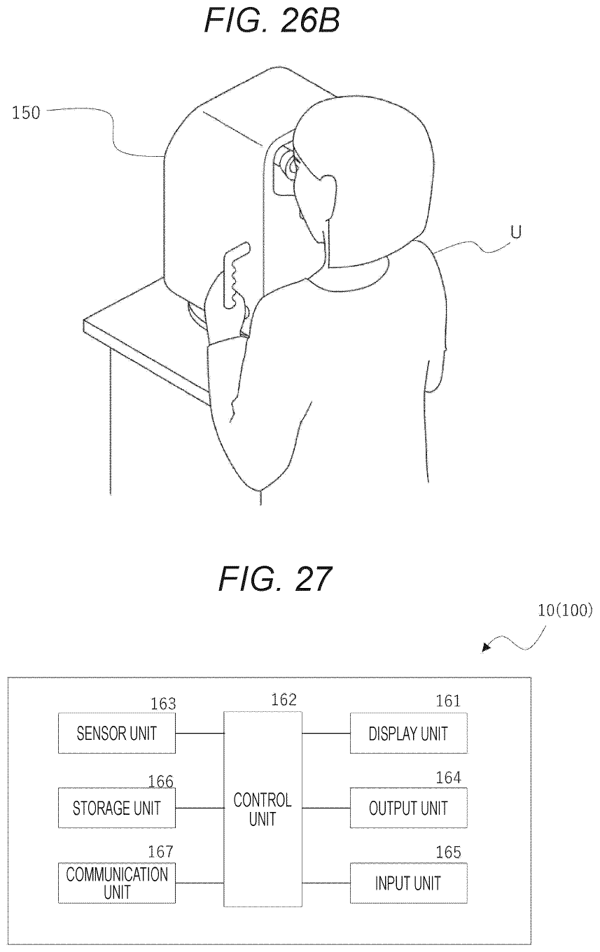

FIGS. 26A and 26B illustrate an example of the appearance of the stationary display device.

The display device 150 illustrated in FIG. 26A has a configuration where the left-eye module and the right-eye module described above are installed in a housing 151. The display device 150 includes an eyepiece 152L for causing the superimposed display light to reach the left eye and an eyepiece 152R for causing the superimposed display light to reach the right eye. The display device 150 may be installed on any desired surface 153 such as a table or a table. The display device 150 may be used in a state where a user U brings his/her face close to the device as illustrated in FIG. 26B, for example.

FIG. 27 is a block diagram of a configuration example of the display device of the present disclosure. As illustrated in the drawing, the display device 10 (100) includes a display unit 161. The display device may further include, for example, a control unit 162, a sensor unit 163, an output unit 164, an input unit 165, a storage unit 166, a communication unit 167, and the like.

The display unit 161 may include the display device module described above, and specifically includes the right-eye module and the left-eye module.

The control unit 162 may include, for example, a central processing unit (CPU) or a graphics processing unit (GPU), or both of them. The control unit controls the operation of each unit and performs various types of arithmetic processing. As described later, the control unit may drive a motor for shifting the position of the display element, perform image correction processing, or the like.

The sensor unit 163 may include, for example, various sensor devices. The sensor unit 163 performs sensing of the user, the surroundings of the user, or the like, and supplies sensor data corresponding to the sensing result to the control unit 162. The control unit 162 may perform image processing, image output, or the like on the basis of the data.

The sensor unit may include at least one of, for example, a magnetic sensor that detects the magnitude and direction of a magnetic field, an acceleration sensor that detects acceleration, a gyro sensor that detects an angle (orientation), angular velocity, or angular acceleration, or a proximity sensor that detects a nearby object.

The sensor unit may include a camera having an image sensor, but the camera may be included in the display unit (specifically, a module). The sensor unit may provide image data obtained by capturing an image of a subject in the control unit 100. The sensor unit may further include at least one of a sensor for measuring an ambient environment such as a temperature sensor that detects temperature, a humidity sensor that detects humidity, and an ambient light sensor that detects ambient brightness, a biometric sensor that detect biometric information such as respiration, pulses, a fingerprint, or an iris, or a sensor for detecting location information such as a global positioning system (GPS) signal.

The output unit 164 may include, for example, an audio output device such as a speaker. The output unit may output audio (sound) corresponding to audio data supplied from the control unit 100. Furthermore, the output unit 164 may include an output terminal. The output terminal may include, for example, an output interface circuit or the like, and may be connected to an electronic device via a predetermined cable. For example, the output terminal may output audio data supplied thereto to a device such as an earphone and a headphone via a cable.

The input unit 165 may include, for example, an input interface circuit or the like. The input unit may be connected to an electronic device via a predetermined cable. For example, the input unit may supply, to the control unit 100, data (for example, image data, audio data, commands, or the like) input from devices such as a game console (dedicated console), a computer, and an image reproducer.

The storage unit 166 may include, for example, a memory, specifically, a non-volatile memory and/or a volatile memory. The memory may include, for example, a semiconductor memory. The storage unit 166 stores various data under control of the control unit 162.

The communication unit 167 may include a communication module that performs wireless communication such as Bluetooth (registered trademark), wireless local area network (LAN), cellular communication (for example, LTE-Advanced, 5G, or the like), or wired communication. The communication unit may communicate with an external device in accordance with a predetermined communication method, and may receive or transmit various data (for example, image data, audio data, commands, or the like). Examples of the external device include, but are not limited to, a game console (dedicated console), a computer, a server, a reproduction device, a dedicated controller, and a remote controller.

### (2) Shift of Display Element

According to one embodiment, at least one of the two or more display elements included in the display device according to the present disclosure may be configured to be shiftable in the optical axis direction. The optical axis direction is a direction orthogonal to the surface of each display element, and specifically corresponds to the optical axis direction of the display light emitted from each display element.

The display element configured to be shiftable in the optical axis direction may include, for example, either or both of the first display element and the second display element described in the above (1). As described above, the display device according to the present disclosure may be configured to make at least one or all of the display elements that emit the display light to be superimposed shiftable in the optical axis direction.

When a certain display element is shifted in the optical axis direction, the position of the virtual image plane formed by the display light emitted from the certain display element can be shifted. That is, shifting the display element allows a change in virtual image distance of the display light emitted from the display element.

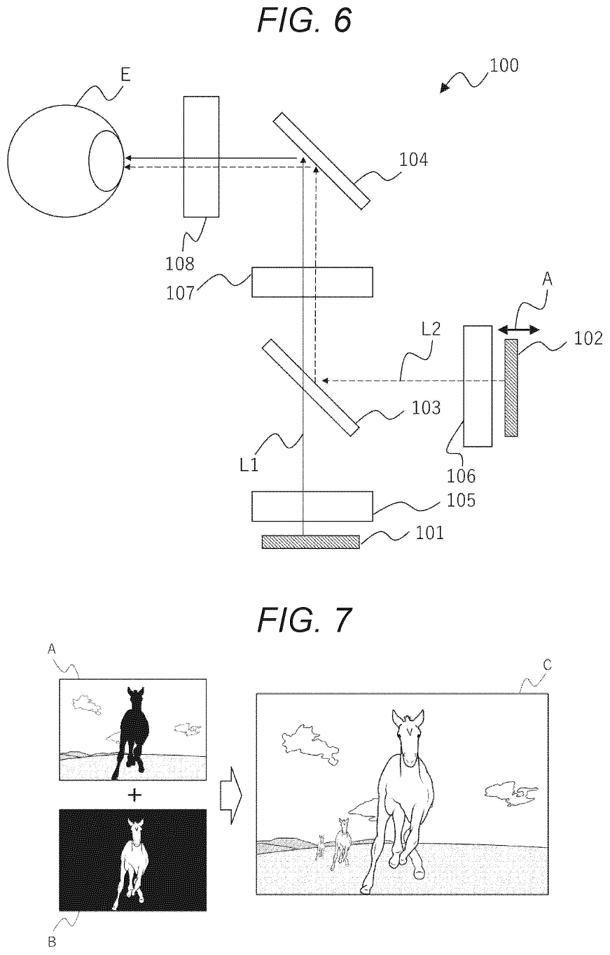

The shift of the display element will be described with reference to FIG. 6. The display device illustrated in the drawing is the same as the display device described with reference to FIG. 3.

The first display element 101 included in the display device 100 emits the first display light L1 corresponding to an image portion perceived by the user as being at a far distance. That is, the first display element 101 emits the first display light L1 that presents, to the user, an image portion whose distance (virtual image distance) from the eyeball of the user to the virtual image is a far distance.

The second display element 102 included in the display device 100 emits the second display light L2 corresponding to an image portion perceived by the user as being at a far to near distance. That is, the second display element 102 emits the second display light L2 that presents, to the user, an image portion whose virtual image distance is between a far distance and a near distance. Furthermore, the second display element is configured to be shiftable in the optical axis direction as indicated by an arrow A in the drawing. That is, in the display device 100, the second display element 102 is movable forward or backward along the optical axis direction.

The shift may be electrically performed, for example. In order to perform the shift, the display device 100 may include a motor (specifically, an electric motor) that moves the second display element 102 in the optical axis direction. Furthermore, the display device 100 may include a control unit that controls the motor. The control unit may be as described above.

For example, as illustrated in FIG. 7, assuming that an image in which a horse runs from the back of the screen toward the front in a grassland and sky background is presented to the user.

In this case, an image of the grassland and sky background should be perceived by the user as being at a far distance. Furthermore, an image of the horse should be perceived by the user as moving from far near.

The first display element 101 emits the first display light L1 that forms an image A of the background. On the other hand, the second display element 102 emits the second display light L2 that presents an image B of the horse.

The virtual image distance of the background is a far distance and need not change. Therefore, the first display element 101 does not move.

On the other hand, the position of the horse changes from far to near. The display device 100 shifts the position of the second display element 102 forward in the optical axis direction (that is, shifts the second display element 102 toward the optical element 103 along the optical axis direction) to shift the virtual image distance from a far distance to a near distance. As a result, as illustrated in an image C in the drawing, it is possible to realistically and naturally present an image in which the horse runs toward the user in the background having a constant virtual image distance.

Furthermore, in order to present an image in which the horse runs away from the user, the display device 100 shifts the position of the second display element 102 backward in the optical axis direction (that is, shifts the second display element 102 away from the optical element 103 along the optical axis direction) to shift the virtual image distance from a near distance to a far distance. For the presentation of the image, first display element 101 need not move.

As described above, changing the position of the second display element 102 without changing the position of the first display element 101 makes it possible to realistically and naturally present, to the user, an image in which an object rendered by the second display element 102 moves toward the user or away from the user.

Furthermore, the first display element 101 may present the image of the horse, and the second display element 102 may present the image of the background. In this case, the display device 100 shifts the first display element 101 and does not shift the second display element 102.

The display device 100 shifts the position of the first display element 101 forward in the optical axis direction to shift the virtual image distance from a far distance to a near distance. On the other hand, the display device 100 shifts the position of first display element 101 backward in the optical axis direction to shift the virtual image distance from a far distance to a near distance.

As describe above, the position of the second display element 102 may be changed without changing the position of the second display element 101.

Furthermore, the display device 100 may shift both the position of the first display element 101 and the position of the second display element 102. It is therefore possible to shift the position of the virtual image plane of the image presented by each of the display elements.

As described above, in one embodiment, the display device of the present disclosure may include the first display element and the second display element, and the optical element that transmits the first display light emitted from the first display element and reflects the second display light emitted from the second display element to form superimposed display light, and the display device may be configured to make either or both of the first display element and the second display element movable in the optical axis direction of the display light emitted from each display element.

Here, each display element may move the position of the display element in the optical axis direction in accordance with the position of the virtual image plane to be formed by the display light emitted from the display element. The manner of the movement may be as described above.

Furthermore, the case where the superimposed display light is formed by the two rays of display light emitted from the two display elements has been described above; however, in the present disclosure, the superimposed display light may be formed by three or more rays of display light emitted from three or more (e.g., three, four, five, six, seven, eight, nine, or ten, specifically three, four, five, or six) rays of display light. That is, the display device of the present disclosure may include three or more display elements. Also in this case, the display device may be configured to make at least one of the display elements shiftable in the optical axis direction, or the display device may be configured to make all the display elements shiftable in the optical axis direction.

### (3) Arrangement of Reflective Element and Optical Element

In a preferred embodiment of the present disclosure, the optical element 103 and the reflective element 104 may be arranged so as to make virtual image distance distribution in an observation plane approximately symmetrical in the left-right direction. As described in the above (2), this embodiment is suitable for reducing or eliminating a difference in virtual image distance between images presented to the left eye and the right eye in a case where the display device according to the present disclosure includes two sets of display device modules.

In this embodiment, the display device according to the present disclosure may include the display device module according to the present disclosure for presenting an image to the left eye (hereinafter, also referred to as “left-eye module”) and the display device module according to the present disclosure for presenting an image to the right eye (hereinafter, also referred to as “right-eye module”). The display device modules may each include the optical element 103 and the reflective element 104. The display device modules may be each configured as described in the above (1) or (2).

It is possible to reduce or eliminate, by arranging the optical element 103 and the reflective element 104 in each module to make the virtual image distance distribution in the observation plane approximately symmetrical in the left-right direction, a difference between the distance of the virtual image formed by the left-eye module and the distance of the virtual image formed by the right-eye module, and it is therefore possible to suppress discomfort when observing the image with both eyes.

In this embodiment, the observation plane may mean a plane observed by the user of the display device, and specifically mean a plane observed by the right eye or the left eye of the user. It is preferable that the virtual image distance distribution in the observation plane of the right eye be approximately symmetrical in the left-right direction, and the virtual image distance distribution in the observation plane of the left eye be approximately symmetrical in the left-right direction, and the right-eye module and the left-eye module (specifically, the optical element 103 and the reflective element 104 included in each of the modules) may be configured accordingly.

In this embodiment, the left-right direction of the virtual image distance distribution in the observation plane may mean the left-right direction in a plane formed by “the optical axis of superimposed display light formed by the left-eye module when the superimposed display light enters the eyeball” and “the optical axis of superimposed display light formed by the right-eye module when the superimposed display light enters the eyeball”, and may correspond to the left-right direction as viewed from the user wearing the display device. The left-right direction will be described below with reference to the drawings.

As described above, the arrangement of the optical element 103 and the reflective element 104 to make the virtual image distance distribution in the observation plane approximately symmetrical in the left-right direction can be achieved, for example, by adjusting a rotation angle around a predetermined axis of the respective surfaces (surfaces on which the display light impinges) of the optical element 103 and the reflective element 104. The rotation angle will be described below.

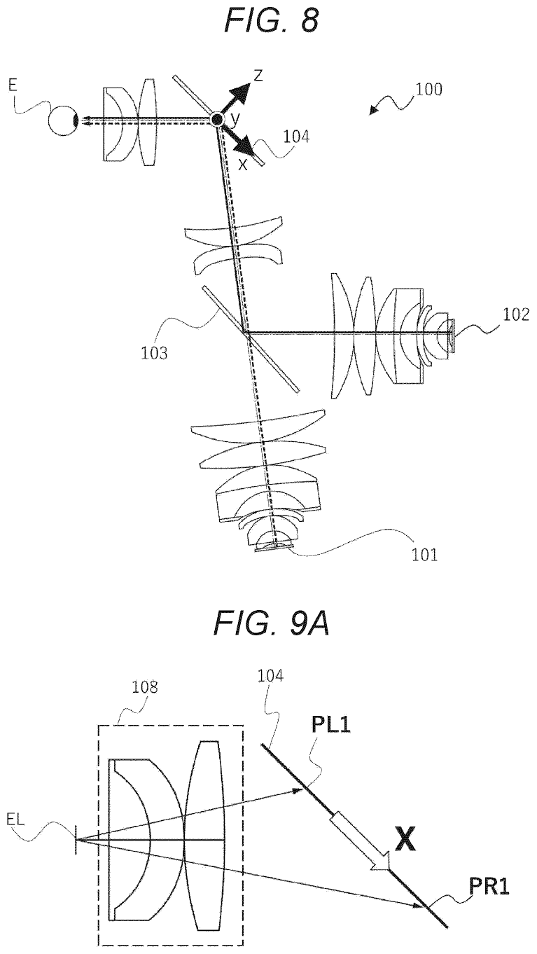

FIG. 8 illustrates the same display device as the display device 100 illustrated in FIG. 4A described above. As illustrated in FIG. 8, local coordinates (x, y, z) for specifying the location of the surface of the reflective element 104 of the display device 100 are defined.

The x axis of the local coordinates is specified as follows. That is, the direction of a line where the “plane formed by the “optical axis of superimposed display light incident on the reflective element 104” and the “optical axis of superimposed display light reflected by the reflective element 104 and traveling toward left eye EL”” and the “reflective surface of the reflective element 104” intersect is defined as the x axis.

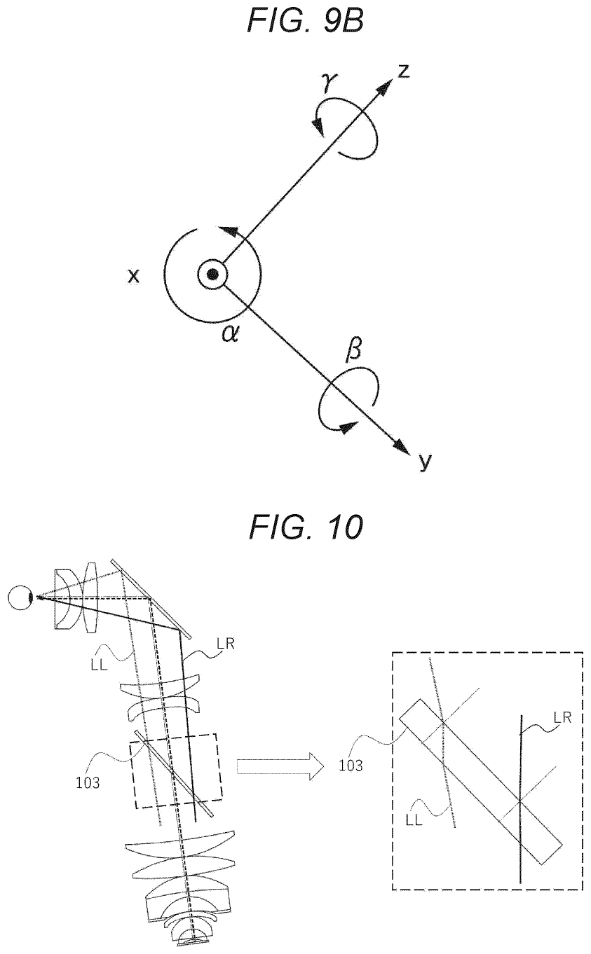

Note that assuming that the plane formed by the two optical axes corresponds to the paper surface illustrated in FIG. 9A, the x axis can also be specified as follows. That is, when two rays of light are emitted from the eyeball leftward and rightward at the same angle relative to the horizontal direction of the plane, and points at which the two rays of light reach the reflective element 104 are denoted as PL1 and PR1, a line connecting PL1 and PR1 may be set as the x axis.

The y axis is an axis that is present on the reflective surface and forms 90° with “the x axis specified as described above”.

The z axis is an axis forming 90° with both the x axis and the y axis specified as described above.

As illustrated in FIG. 9B, regarding the reflective surface of the reflective element 104, α1 denotes a rotation angle of the reflective surface around the x axis, β1 denotes a rotation angle of the reflective surface around the y axis, and γ1 denotes a rotation angle of the reflective surface around the z axis.

Similarly, local coordinates (x, y, z) are set for the surface of the optical element 103 (the surface from which the superimposed display light is emitted). The local coordinates are set such that a point of intersection of the x axis, the y axis, and the z axis is arranged at a point where the surface of the optical element 103 intersects the optical axis of the superimposed display light, and the three axes extend in the same directions as the local coordinates of the reflective element 104.

Also regarding the surface of the optical element 103 (the surface from which the superimposed display light is emitted), α2 denotes a rotation angle of the surface of the optical element 103 around the x axis, β2 denotes a rotation angle of the surface around the y axis, and γ2 denotes a rotation angle of the surface around the z axis.

In a case where the rotation angles of the reflective element 104 and the optical element 103 are specified as described above, when the reflective element 104 and the optical element 103 are arranged so as to satisfy β1=β2 and γ1=γ2, the virtual image distance distribution in the observation plane becomes approximately symmetrical in the left-right direction. That is, in a preferred embodiment of the present disclosure, the reflective element 104 and the optical element 103 are arranged so as to satisfy the conditions β1=β2 and γ1=γ2.

As illustrated on the left and right of FIG. 10, even when the first display light L1 of the optical system 1 transmitted through the optical element 103 includes light LL and light LR that generate the same angle of view, the light LL and light LR are different in angle of incident on the half mirror. Therefore, the light LL and the light LR suffer changes in optical distance due to refraction in the optical element 103, and as a result, the in-plane virtual image distance distribution becomes non-rotationally symmetrical.

Therefore, as described above, arranging the optical element 103 and the reflective element 104 so as to make the virtual image distance distribution in the observation plane approximately symmetrical in the left-right direction can enhance the symmetry of the virtual image distance distribution.

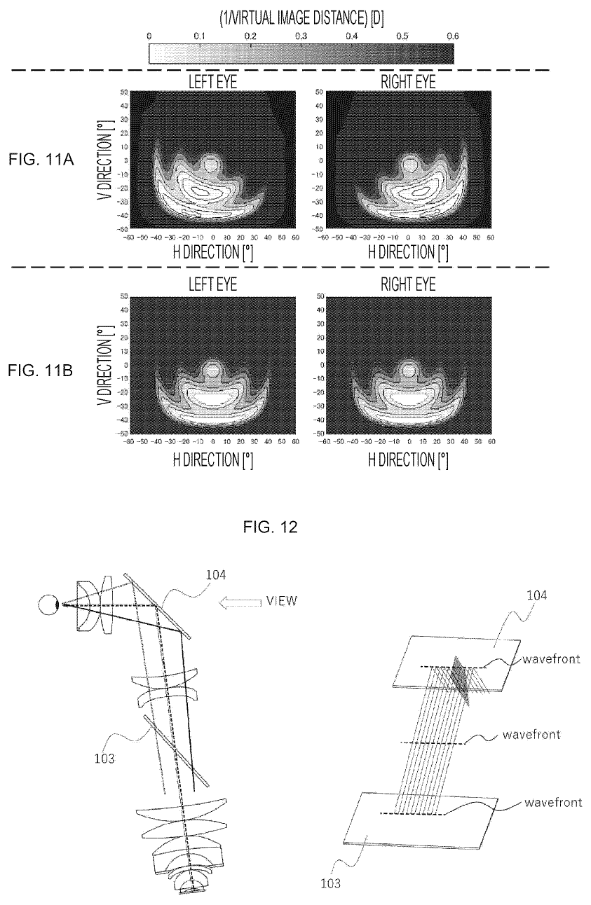

FIG. 11 shows analysis results of the virtual image distance distribution in the observation plane in each of (i) a case where the optical element 103 (half mirror) is arranged relative to the reflective element 104 so as not to satisfy the above-described conditions and (ii) a case where the optical element is arranged relative to the reflective element so as to satisfy the above-described conditions. Note that the gray-scale graph indicates a diopter and is the reciprocal of the virtual image distance expressed in meters.

As shown in the analysis results in the drawing, in the case (i) where the optical element and the reflective element are arranged so as not to satisfy the above-described conditions, the virtual image distance distribution is asymmetrical in both the left-right direction and the up-down direction.

On the other hand, in the case (ii) where the optical element and the reflective element are arranged so as to satisfy the above-described conditions, the virtual image distance distribution is asymmetrical in the up-down direction, but is symmetrical in the left-right direction. Here, when focusing on a specific region (H direction: 30°, V direction: −30°) in the observation plane, the arrangement not satisfying the above-described conditions causes a difference in virtual image distance between the left eye and the right eye, which causes discomfort. On the other hand, the arrangement satisfying the above-described conditions causes no difference in virtual image distance between the left eye and the right eye, and it is therefore possible to suppress discomfort during observation.

As described above, it is possible to eliminate, by adjusting the rotation angles of the surfaces of the reflective element 104 and the optical element 103, the difference in virtual image distance between the right eye and the left eye.

Furthermore, FIG. 12 illustrates the behavior of light between the two reflective elements when a plane wave propagates forward from an aperture connecting the pupil centers of the right and left eyes. As illustrated in the drawing, wavefronts incident on from the back side of the drawing and reflected by the reflective element 104 impinge on the optical element 103. Here, when the optical element 103 is arranged relative to the reflective element 104 so as to satisfy the above-described conditions, the wavefronts and the surface of the optical element 103 become parallel. Accordingly, light incident on the optical element 103 and forming the horizontal angle of view exhibits left-right symmetry with respect to the optical axis. As a result, the in-plane virtual image distance distribution of the optical system becomes bilaterally symmetrical, which allows a reduction in discomfort.

### (4) Tilt of First Display Element

As described above, the first display light L1 transmitted through the optical element 103 is refracted in the optical element 103 to make the virtual image distance in the observation plane asymmetrical.

In the present disclosure, in a case where the reflective element 104 and the optical element 103 are arranged so as to satisfy the conditions described in the above (3), a tilt δ of the first display element 101 relative to the lens optical axis may be adjusted. The tilt δ means a rotation angle of the surface of the display element around a predetermined axis. That is, in the present disclosure, the first display element may be arranged so as to cause the display surface of the first display element to tilt relative to the plane orthogonal to the optical axis of the first display light.

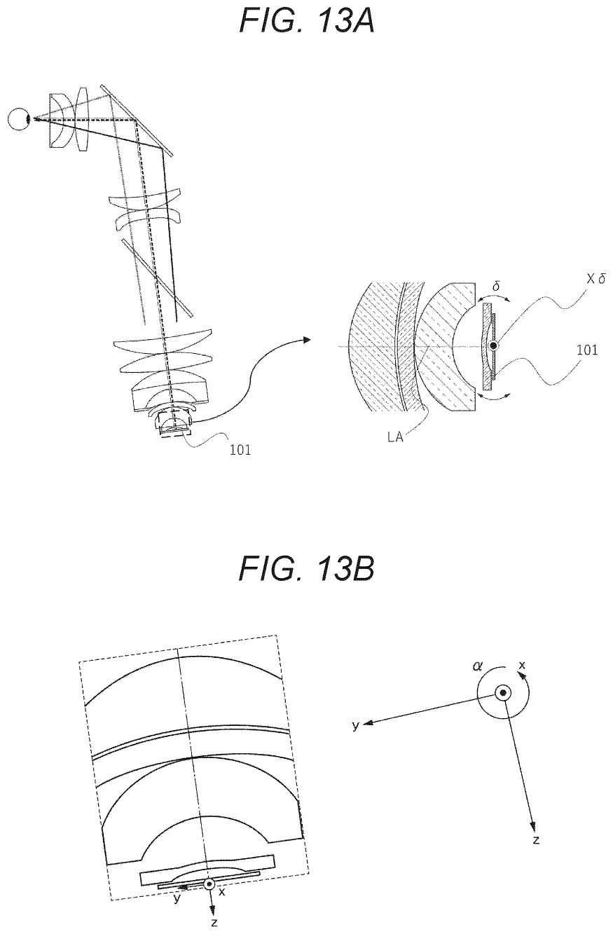

For example, the tilt δ is a rotation angle of the surface of the first display element 101 around an axis Xδ as illustrated in FIGS. 13A and 13B.

The axis Xδ illustrated in the drawing is an axis that is on the surface of the first display element 101, passes through the intersection of the optical axis of the first display light L1 and the first display element 101, and is orthogonal to the “plane formed by the “optical axis of superimposed display light incident on the reflective element 104” and the “optical axis of superimposed display light reflected by the reflective element 104 and traveling toward left eye EL”” described in the above (3).

When the surface of the first display element 101 is orthogonal to the optical axis of the first display light L1, the tilt δ is set to 0°. Then, a tilt δ by which rotation is made so as to make the angle between the incident surface of the optical element 103 on which the first display light L1 impinges and the surface of the first display element 101 larger is defined as a positive rotation angle, and a tilt δ by which rotation is made so as to make the angle smaller is defined as a negative rotation angle. That is, the counterclockwise direction on the paper corresponds to the positive direction.

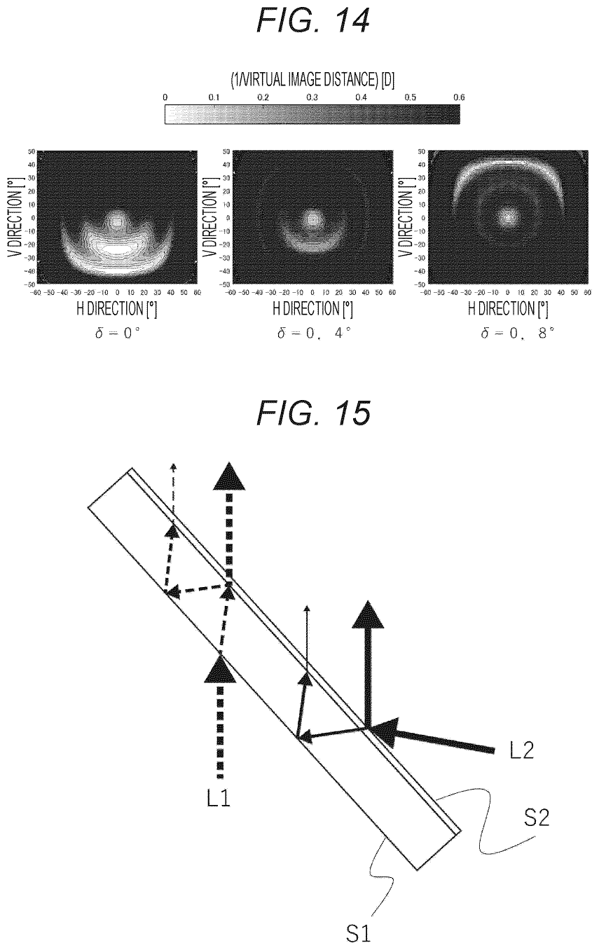

In this case, virtual image distance distribution in each case where the tilt δ is 0°, 0.4°, and 0.8° was analyzed. The analysis results are shown in FIG. 14. As shown in the drawing, it can be seen that, in a case where the tilt δ is 0°, there is a large difference (partial blur) in virtual image distance in the up-down direction, whereas in a case where δ is 0.4°, the difference in virtual image distance in the up-down direction decreases, which makes the characteristics uniform in the plane. Furthermore, in a case where δ is 0.8°, the difference in virtual image distance in the up-down direction increased again. As described above, it is possible to reduce, by adjusting the tilt δ, a difference in virtual image distance in the observation plane.

That is, in a preferred embodiment of the present disclosure, the first display element 101 may be arranged so as to have the tilt δ. Having the tilt δ means that the tilt δ is larger than 0°.

For example, the tilt δ may be larger than 0°, preferably larger than or equal to 0.01°, or more preferably larger than or equal to 0.05°, and may be, for example, larger than or equal to 0.1° or larger than or equal to 0.2°.

Furthermore, the tilt δ may be preferably smaller than 0.8°, more preferably smaller than or equal to 0.7° or smaller than or equal to 0.6°.

It is possible to cause, by arranging the reflective element 104 and the optical element 103 as described in the above (3) and arranging the first display element 101 as described in the above (4), the display element according to the present disclosure to make the virtual image distance distribution in the observation plane uniform in both the left-right direction and the up-down direction. That is, in one embodiment, in the display device according to the present disclosure, the optical element 103 and the reflective element 104 are arranged so as to make the virtual image distance distribution in the observation plane approximately symmetrical in the left-right direction, and the first display element 101 is arranged so as to have a tilt.

### (5) AR Coating

In a preferred embodiment, an antireflection film may be provided on the surface on which the first display light L1 emitted from the first display element 101 impinges, of the two surfaces of the optical element 103. That is, the optical element 103 may have an antireflection film laminated on the surface on which the first display light L1 impinges. The antireflection film is also called antireflection (AR) coating.

As illustrated in FIG. 15, when focusing on the first display light L1 transmitted through the optical element 103, a part of the first display light L1 incident on a surface S1 of the optical element 103 (for example, a half mirror) is transmitted through a surface S2, and the remaining part of the first display light L1 is reflected by the surface S2. The reflected light impinges on the surface S1 again, and a part of the reflected light is reflected due to interface reflection, impinges on the surface S2 again, and is transmitted through the surface S2. A component subjected to the interface reflection goes out from a position away from light that originally becomes a signal, and as a result, the component becomes stray light and is visible as a double image.

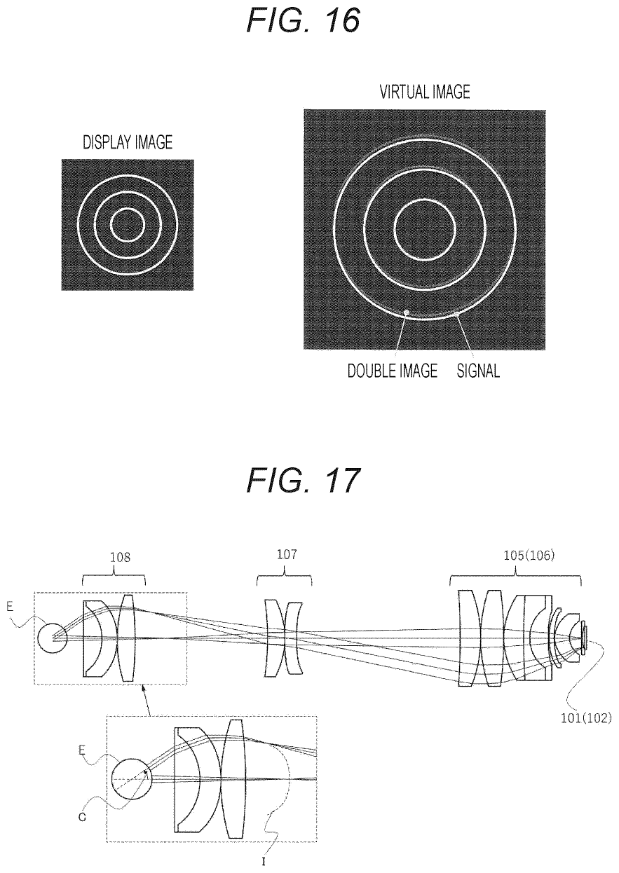

FIG. 16 illustrates an example of the double image. The drawing illustrates an image obtained by analyzing the behavior of the stray light and deforming a double image. The left of the drawing is an example of an image displayed by the display element on the surface of the display element, and is an example of a virtual image visible to the user based on the image display light emitted from the display element. Three concentric circles are displayed on the left of the drawing. The right of the drawing illustrates, in addition to three concentric virtual images corresponding to the three concentric circles, a double image near each concentric circle. Due to the stray light generated in the optical element 103, such a double image may be visible. This double image is particularly noticeable against an image with a black background, which becomes a factor in deteriorating image quality.

Note that the second display light L2 suffers a similar phenomenon. That is, a part of the second display light L2 is not reflected by the surface S2 but is transmitted through the surface S2 to reach the surface S1. Then, the part of light is reflected off the surface S1 due to interface reflection, and then impinges on the surface S2 again, and is transmitted through the surface S2.

As described above, since the antireflection film is provided on the surface S1, it is possible to reduce the amount of light reflected off the surface S1 due to the above-described interface reflection. As a result, as described above, the generation of stray light can be prevented, which results in no double image being visible. Since the double image is caused by interface reflection on the surface S1, the antireflection film provided on the surface S1 can reduce the intensity of the double image.

The antireflection film may include a material known in the art, and may include, for example, a dielectric film-forming material. The antireflection film may include, for example, MgF₂ or SiO₂, or both of them. The antireflection film may include such a material, but the material for forming the antireflection film is not limited to the above-described materials, and may be selected as appropriate by a person skilled in the art.

### (6) Metal Film

In a preferred embodiment, a metal film may be provided on the surface on which the second display light L2 emitted from the second display element 102 impinges, of the two surfaces of the optical element 103. That is, the optical element 103 may have a metal film formed on the surface that reflects the second display light L2.

As described in the above (5), stray light is generated on the surface S1 of the optical element 103 (for example, a half mirror) due to interface reflection, which may result in a double image being visible. Here, the signal component is transmitted through the optical element 103 once (first display light L1) or reflected once (second display light L2), whereas the component forming the double image is transmitted through or reflected by the optical element twice. Accordingly, the half mirror with the metal film can absorb light, so that the intensity of the component forming the double image can be reduced.

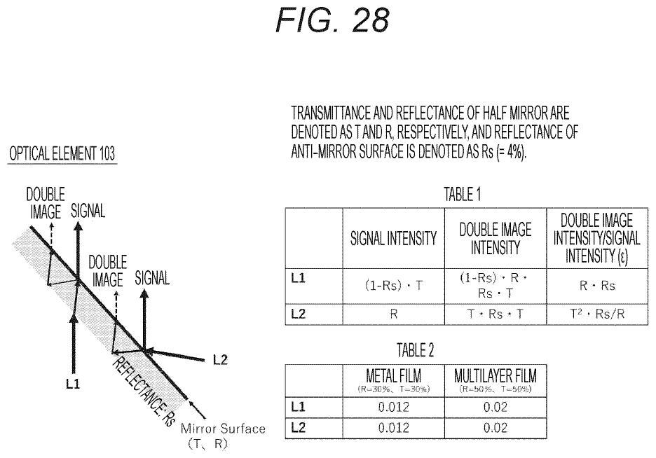

For example, the half mirror with the metal film not only reflects and transmits light but also absorbs light. Here, assuming that the half mirror with the metal film has a reflectance of 40% and a transmittance of 40%, the remaining 20% is absorbed by the metal film. As shown in FIG. 28, when the transmittance of the half mirror is denoted as T, and the reflectance is denoted as R, the intensity of the signal, the intensity of the double image, and a value (ϵ) obtained by dividing the intensity of the double image by the intensity of the signal are represented as in Table 1 in the drawing. Here, as the value ϵ is smaller, the double image becomes smaller in intensity than the signal, indicating that the image quality is high.

Here, assuming that the following two half mirrors are provided.
Metal film (R=40%, T=40%)
Dielectric multilayer film (R=50%, T=50%) When the reflectance and transmittance values of each of

the films are substituted into expressions shown in Table 1, the value ϵ is smaller for the metal film(indicating that the image quality is higher for the metal film. Forming the metal film on the surface S2 as described above

allows an increase in reflectance of the second display light L2 and thus allows a reduction in the amount of light that may form a double image.

It is desirable that the metal film include a material such as aluminum or silver. Furthermore, in order to increase the reflectance, an enhanced reflective coating may be applied to the surface of the metal film.

### (7) No Lens Is Arranged at or Near Position Where Intermediate Image Is Formed

Regarding the display device of the present disclosure, as described above, the light guide optical system may be configured to form an intermediate image at least once on the optical path between the eyeball and each display element. In the display device of the present disclosure, it is preferable that an optical component such as a lens or a reflective element be not arranged at or near the position where the intermediate image is formed. That is, the display device of the present disclosure may be configured such that an area at and near the position where the intermediate image is formed is occupied by air.

Note that, as illustrated in FIG. 17, the position where the intermediate image is formed is defined as a plane connecting points where light flux in a line-of-sight direction forms an image when the eyeball undergoes two-dimensional cycloduction. The cycloduction is indicated by a symbol C in the drawing. The position where the intermediate image is formed is indicated by a symbol I in the drawing.

As described above, when a lens is present, for example, at and near the position where the intermediate image is formed, there is a possibility that slight irregularities on the surface of the lens becomes visible, or contrast is reduced by internal scattered light of a glass material. The above leads to deterioration of image quality, so that it is desirable that neither a lens nor a reflective element be arranged near the intermediate image illustrated in the drawing.

### (8) Shape of Lens Optical System

In one embodiment of the present disclosure, two or more lens optical systems provided on the optical path between each display element and the optical element coincident with the display element may have the same configuration. That is, the two or more lens optical systems may have the same shape and number of lenses included in each lens optical system.

For example, as described in the above (1), the light guide optical system 14 illustrated in FIG. 2 includes the lens optical system 15 provided on the optical path between the first display element 11 and the optical element 13 and the lens optical system 16 provided on the optical path between the second display element 12 and the optical element 13. The lens optical system 15 may be identical in configuration to the lens optical system 16.

Furthermore, the lens optical systems 15 and 16 correspond to the lens optical system 105 and the lens optical system 106 in FIG. 3, respectively. That is, the lens optical system 105 may be identical in configuration to the lens optical system 106.

As described above, the light guide optical system may include the lens optical system arranged on the optical path between the first display element and the optical element and the lens optical system arranged on the optical path between the second display element and the optical element, and the two lens optical systems may have the same configuration.

In this embodiment, since the first display light L1 and the second display light L2 superimposed by the optical element 103 impinge on the eyeball via the same lens optical system, the two rays of display light produce approximately the same amount of aberration. As a result, a boundary between the rays of display light becomes less noticeable, and it is therefore possible to make the image look natural.

It is desirable that the lenses included in the two or more lens optical systems having the same configuration as described above have the same shape, but it is acceptable as long as the lenses fall within a range of a depth of focus of the optical system where blur is less noticeable. The depth of focus may be obtained by a product of an F value of the optical system and a permissible circle of confusion diameter. The permissible circle of confusion diameter may be determined by one pixel size of the display element. That is, the two or more lens optical systems provided on the optical path between each display element and the optical element coincident with the display element may be exactly the same, but may have similar configurations as permitted above.

In a more preferred embodiment, two or more display elements that emit display light to be superimposed may also be the same as each other. It is therefore possible to reduce a difference in luminance or chromaticity. For example, the first display element and the second display element in FIG. 2 or 3 may be the same.

### (9) Image Correction

As described in the above (2), the display device of the present disclosure may be configured to make at least one display element shiftable in the optical axis direction. The shift in the optical axis direction can change the virtual image distance, but at the same time, may slightly change the magnification of the display light emitted from the display element.

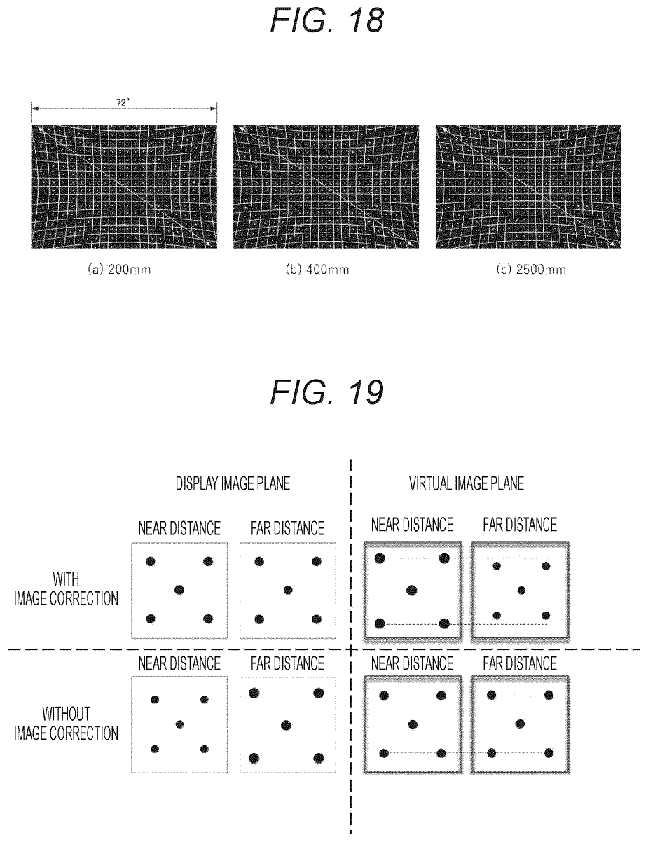

The change in magnification will be described with reference to FIG. 18. The drawing shows analysis results of visible images on the virtual image plane when the same evaluation pattern is displayed on the display element at various virtual image distances (200 mm, 400 mm, and 2500 mm). Note that, in this drawing, in order to make a difference in magnification clear, an arrow with the same size is drawn in each display result of the evaluation pattern.

As shown in the drawing, it can be seen that a change in virtual image distance causes a slight change in magnification. When images of two or more rays of display light are superimposed in this state, the images become misaligned, and specifically, peripheral regions of the images become misaligned. Such an image misalignment affects superimposition.

The display device of the present disclosure may be configured to correct an image displayed by each display element in accordance with two or more rays of display light to be superimposed (for example, in accordance with the magnification of each ray of display light). For example, the correction may be performed such that images are superimposed on the virtual image plane. It is therefore possible to prevent the image misalignment described above. The display device may include a control unit that controls a display element that emits display light of an image to be corrected. The control unit may perform the image correction described above. The control unit is as described above, and includes, for example, a CPU, a GPU, or both of them. The CPU or GPU may perform information processing for the image correction.

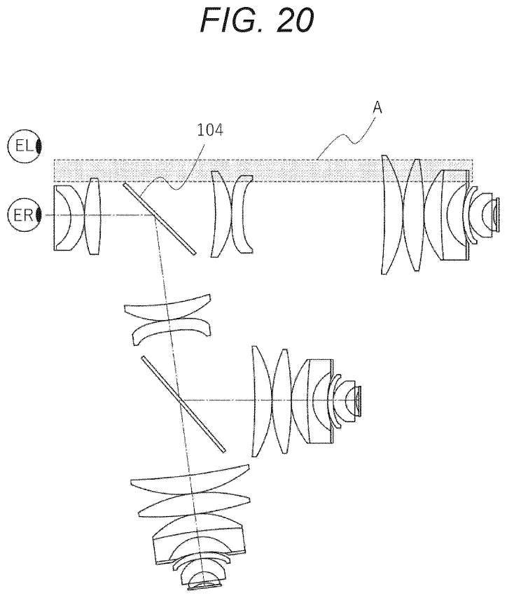

FIG. 19 illustrates a schematic example of the image correction. As illustrated in the drawing, when the magnification increases, that is, when the virtual image distance is short, the image correction may be performed so as to make the size of the image displayed by the display element larger. On the other hand, when the magnification decreases, that is, when the virtual image distance is long, the image correction may be performed so as to make the size of the image displayed by the display element smaller. The display device (for example, the control unit) may perform such image correction. It is therefore possible to enhance superimposition.

### (10) Reflective Element That Does Not Transmit Light

In a preferred embodiment, the reflective element 104 may be configured not to transmit light. For example, the reflective element may be a mirror that does not transmit light. In the embodiment, the reflective element may be arranged so as to reflect superimposed display light traveling from one ear side to cause the superimposed display light to reach the eyeball on the same side as the ear. For example, the reflective element may be arranged so as to reflect superimposed display light traveling from the left ear side to cause the superimposed display light to reach the left eye. Furthermore, the reflective element may be arranged so as to reflect superimposed display light traveling from the right ear side to cause the superimposed display light to reach the right eye. With the reflective elements arranged as described above, the angle of view of each virtual image plane to be superimposed can be increased.

As described above, the display device of the present disclosure may include the right-eye module and the left-eye module. That is, the display device may be configured to allow the user to observe an image with two eyes. In a case where the image is observed with two eyes as described above, a distance between the right eye and the left eye puts limitations on dimensions of the optical components (for example, the outer diameter of a lens) included in each of the right-eye module and the left-eye module so as to prevent the optical components of the right-eye module and the optical components of the left-eye module from interfering with each other. This limitation is strong particularly in a case where the angle of view of the image display light is increased, and this is because the lens aperture increases in response to the increase in the angle of view.

Here, when the reflective element 104 is configured as a half mirror, and the display element is configured to cause a part of the display light forming superimposed display light to transmit the reflective element to form the superimposed display light, the position of the lens of the display device modules for the right eye ER and the position of the lens of the display device module for the left eye EL may overlap each other as in a portion overlapping with a region indicated by a symbol A in FIG. 20. In order to prevent such an overlap, it is necessary to cut a part of the lens, but this narrows the angle of view.

Therefore, a configuration where the reflective element 104 includes a mirror that reflects light without transmitting the light, and the mirror is configured to reflect display light traveling from the ear side to cause the display light to reach the eye on the ear side prevents the lens group on the display element side from being subjected to limitations as described above imposed by the reflective element and eliminates the need of cutting the lens, for example. It is therefore possible to increase flexibility in the configuration of the light guide optical system.

In the drawing, the reflective element 104 is configured to reflect superimposed display light traveling from below (specifically, obliquely below) with the display device mounted to cause the superimposed display light to reach the eyeball, but it is obvious that the configuration of the display device of the present disclosure is not limited to such a configuration. For example, with the display device mounted, the superimposed display light may travel toward the reflective element from left or right or from above.

Note that, by using a half mirror as the reflective element and turning off only the display element that emits the display light transmitted through the half mirror, it is also possible to use the reflective element so as not to sacrifice the angle of view of all the rays of display light to be superimposed. In a case where the reflective element includes a half mirror, there is, however, a possibility that luminance decreases as compared with a case where the reflective element includes a mirror. It is therefore desirable that the reflective element include a mirror having high reflectance and not transmitting light.

### (11) Modification

### (11-1: Adjustment to Virtual Image Distance)

In the present disclosure, only the display element may be shifted in the optical axis direction in order to adjust the virtual image distance, but the virtual image distance adjustment method is not limited to such a method. For example, the virtual image distance may be adjusted by moving any one of the lenses included in the light guide optical system (specifically, a lens closest to the eye or a lens closest to the display element) and the display element together as a set. Furthermore, the virtual image distance may be adjusted by moving any one of the lenses included in the light guide optical system. The display device of the present disclosure may be configured to be able to compensate for a focus change due to the eye adjustment as described above.

### (11-2: Varifocal Lens)

Furthermore, the adjustment to the virtual image distance that is performed by the display element of the present disclosure may be performed using a varifocal lens such as a liquid crystal lens. That is, the light guide optical system of the display device of the present disclosure may include the varifocal lens. The display device may be configured to adjust the distance of the virtual image formed by each ray of display light with the varifocal lens.

The varifocal lens may include, for example, a liquid varifocal lens. Examples of the varifocal lens may include a varifocal lens whose focal length is electrically adjusted. The varifocal lens may be included in, for example, one or more of the lens optical systems 15, 16, and 17 of the light guide optical system 14 illustrated in FIG. 2, and may be included specifically in the lens optical system 15 or 16, or both of them. The varifocal lens may be included in, for example, one or more of the lens optical systems 105, 106, 107, and 108 of the light guide optical system 109 illustrated in FIG. 3, and may be included specifically in the lens optical system 105 or 106, or both of them. The varifocal lens may be included in a lens optical system on the optical path between each display element and an optical element that superimposes two or more rays of display light.

### (11-3: Imaging Element)

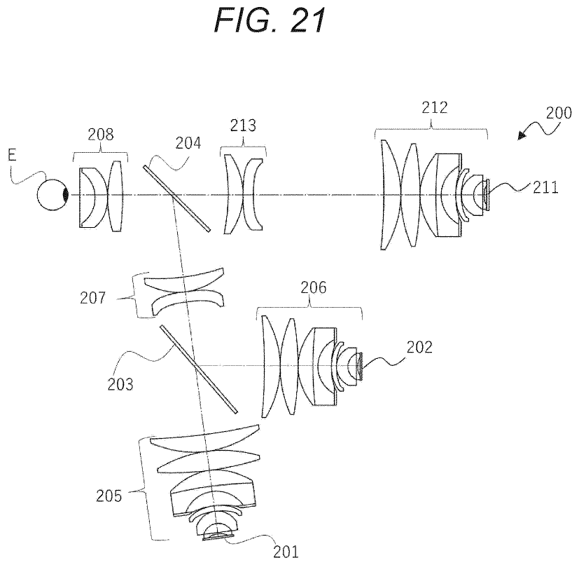

Furthermore, the display device of the present disclosure may include an imaging element. It can also be said that the display device described above with reference to FIGS. 2 and 3 includes two display elements, that is, includes two optical systems including the display elements. The display device of the present disclosure may include three or more optical systems, and moreover, one or more of the three or more optical systems may be an optical system including an imaging element. A configuration example of the display device including an imaging element is illustrated in FIG. 21. A display device 200 illustrated in the drawing has a configuration where an optical system including an imaging element is added to the display device 100 illustrated in FIG. 4A. The display device 200 will be described below.

The display device 200 includes a first display element 201, a second display element 202, an optical element 203, a reflective element 204, and lens optical systems 205 to 208. These components correspond to the first display element 101, the second display element 102, the optical element 103, the reflective element 104, and the lens optical systems 105 to 108 in FIG. 4A, and the description regarding FIG. 4A also applies to the display device 200.

The display device 200 further includes an imaging element 211 and lens optical systems 212 and 213. The imaging element 211 may be configured to detect, for example, the movement of an eyeball (specifically, detect in real time). The display device 200 may perform line-of-sight estimation on the basis of the detection result. The display device 200 may be configured to dynamically change a distance of a virtual image generated by the display element 201, a distance of a virtual image generated by the display element 202, or the distances of both the virtual images on the basis of the estimated line-of-sight. It is possible to grasp, through the line-of-sight estimation and the change in the virtual image distance, an object of interest to which the user is paying attention and then provide a natural and highly immersive image experience.

Furthermore, the lens optical systems 212, 213, and 208 may be configured to cause light from the eyeball E to form an intermediate image at least once on the optical path between the eyeball E and the imaging element 211. For example, the light from the eyeball E may form an intermediate image at least once on the optical path between the lens optical systems 208 and 213. The optical path may be an optical path that extends from the eyeball in the opposite direction from the optical path illustrated in FIG. 5.

### (11-4: Increase in Number of Virtual Image Planes)

With the configuration example of each display device illustrated in FIGS. 2 and 3, the display device forms two virtual image planes. The number of virtual image planes formed by the display device of the present disclosure is not limited to two for one eyeball, and may be three or more. It is possible to adjust the number of virtual image planes as appropriate by adjusting the number of optical elements that superimpose display light, the number of reflective elements, and the arrangement of these elements. Then, the light guide optical system is arranged on the optical path so as to cause the display light emitted from each display element to form an intermediate image at least once on the optical path.

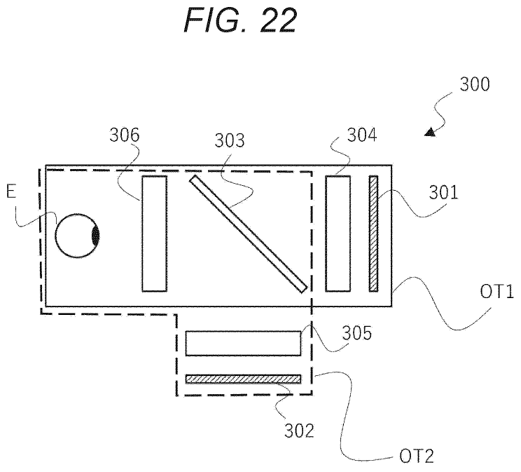

In the above (1), the display devices in which two virtual image planes are formed have been described with reference to FIGS. 2 and 3. As illustrated in FIG. 22, these display devices are each regarded as including a basic optical system OT1 regarding the first display light and an additional optical system OT2 regarding the second display light. A display device 300 illustrated in the drawing will be described below.

The display device 300 includes the basic optical system OT1 and the additional optical system OT2.

The basic optical system OT1 includes not only a display element 301 and an optical element 303 for superimposing display light but also lens optical systems 304 and 306 as a light guide optical system.

The additional optical system OT2 includes not only a display element 302 and the optical element 303 for superimposing display light but also lens optical systems 305 and 306 as a light guide optical system.

The first display light of the basic optical system OT1 is not reflected by the optical element 303 located on the optical path of the first display light, but is always transmitted and reaches the eyeball E.

The second display light of the additional optical system OT2 is reflected by the optical element 303 and superimposed on the first display light. The superimposed display light thus superimposed reaches the eyeball E.

In the present specification, the basic optical system may mean an optical system in which display light emitted from a display element included in the basic optical system is transmitted without being reflected by any of one or more display light superimposing optical elements arranged on the optical path of the display light and reaches an eyeball.

In FIG. 22, there is one optical element (for example, a half mirror) that superimposes display light, and in this case, the display device has two virtual image planes. In the present disclosure, it is possible to increase the number of virtual image planes by adding an optical element for superimposing display light on the above-described first optical system.

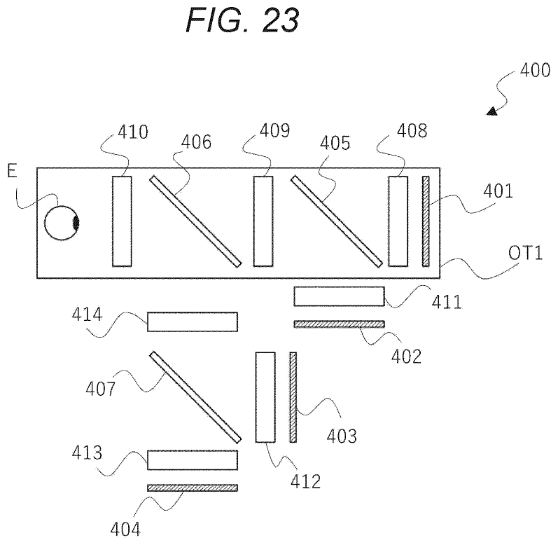

FIG. 23 illustrates a configuration example of a display device having four virtual image planes. In the drawing, a display device 400 includes a basic optical system OT1. The basic optical system OT1 includes a display element 401 and optical elements 405 and 406 for superimposing display light, and further includes lens optical systems 408, 409, and 410 as a light guide optical system. The two optical elements are arranged on an optical path of the basic optical system OT1, so that four virtual image planes can be formed.

In the drawing, the optical element 405 reflects display light emitted from a display element 402 to superimpose the display light on display light emitted from the display element 401.

Furthermore, the optical element 406 reflects display light emitted from each of display elements 403 and 404 to superimpose the display light on the display light emitted from the display element 401.

Note that the display light of the display element 403 and the display light of the display element 404 are superimposed by an optical element 407.

As described above, the two optical elements 405 and 406 on the basic optical system OT1 superimpose the rays of display light emitted from the display elements 402, 403, and 404 on the display light emitted from the display element 401. The display device 400 can therefore form up to four virtual image planes. Note that three virtual image planes may be formed by removing any one of the display elements 401 to 404 (or replacing any one of the display elements 401 to 404 with an imaging element).

Furthermore, the light guide optical system of the display device 400 may be configured to cause the display light from each display element to form an intermediate image at least once on the optical path between the display element and the eye.

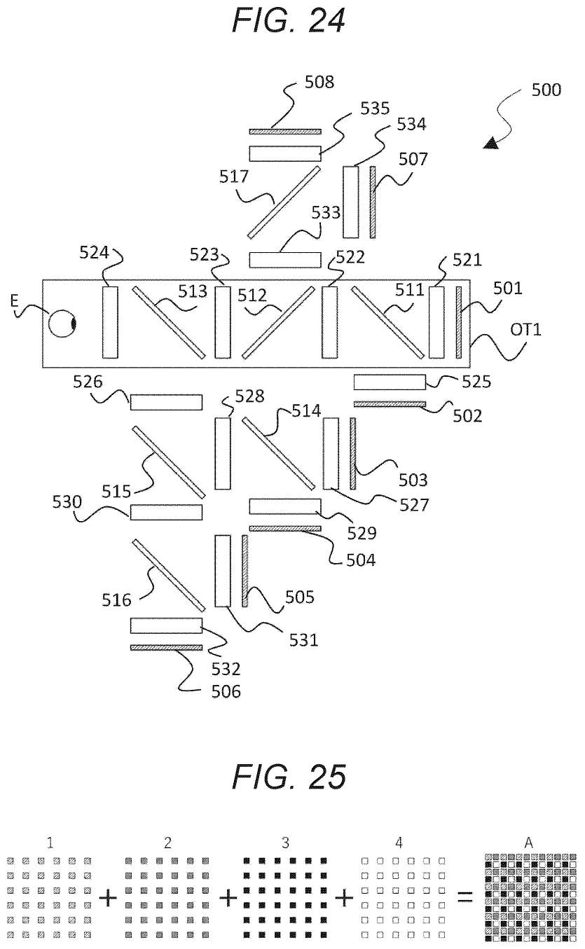

FIG. 24 illustrates a configuration example of a display device having eight virtual image planes. In the drawing, a display device 500 includes a basic optical system OT1. The basic optical system OT1 includes a display element 501 and three optical elements 511 to 513 for superimposing display light, and further includes lens optical systems 521 to 524 as a light guide optical system. The three optical elements are arranged on an optical path of the basic optical system OT1, so that eight virtual image planes can be formed.

In the drawing, the optical element 511 reflects display light emitted from a display element 502 to superimpose the display light on display light emitted from the display element 501.

Furthermore, the optical element 512 reflects display light emitted from each of display elements 507 and 508 to superimpose the display light on the display light emitted from the display element 501.

Furthermore, the optical element 513 reflects display light emitted from each of display elements 503 to 506 to superimpose the display light on the display light emitted from the display element 501.

As described above, the three optical elements 511 to 513 on the basic optical system OT1 superimpose the rays of display light emitted from the display lights 502 to 508 on the display light emitted from the display element 501. The display device 500 can therefore form up to eight virtual image planes.

Note that seven or less virtual image planes may be formed by removing at least any one of the display elements 501 to 508 (or replacing at least any one of the display elements 501 to 508 with an imaging element).

Furthermore, the light guide optical system of the display device 500 may be configured to cause the display light from each display element to form an intermediate image at least once on the optical path between the display element and the eye.

As described above, the display device of the present disclosure may be configured to be able to form two or more virtual image planes.

The display element of the present disclosure may be configured to make the virtual image distances of the rays of display light emitted from two or more display elements uniform. That is, the display device may be configured to form the virtual image plane formed by each ray of display light at the same position. The display device can therefore enhance the resolution of an image presented to the user in a pseudo manner.

### (11-5: Resolution Enhancement)

For example, as illustrated in FIG. 25, in a case where four rays of display lights 1, 2, 3, and 4 emitted from four display elements are superimposed, it is possible to form an image A with four times the resolution by superimposing the four rays of display lights 1, 2, 3, and 4 with the respective virtual image distances of the optical systems made uniform. For example, in a case where the display element has the FHD resolution, it is possible to achieve the 4K resolution by superimposing the virtual image planes. According to this embodiment, a high resolution that cannot be obtained by an existing display element can be achieved. Furthermore, according to this embodiment, it is also possible to increase the resolution by using a plurality of inexpensive display elements.

Note that, in this embodiment, the display device may be configured to be able to shift the pixel position of each optical system. Therefore, the resolution can be appropriately increased. For such a shift, the display device may be configured to be able to move the display element within the display surface of the display element. For example, the control unit may control a motor that changes the position of the display element to perform the movement within the plane.

For example, in order to increase the resolution of the display devices illustrated in FIGS. 2 and 3, the display devices may be configured to shift either or both of the position of the virtual image plane formed by the first display light and the position of the virtual image plane formed by the second display light to align the positions of the virtual image planes. Furthermore, as described the above (11-4: Increase in number of virtual image planes), the number of rays of display light to be superimposed may be increased by further adding a display element.

As described above, the display device of the present disclosure may be configured to present, using two or more rays of display light, one image having higher in resolution than each ray of display light.

### 3. Second Embodiment (Display Device Module)

The present disclosure also provides the display device module described in the above 2. That is, a display device module provided by the present disclosure may include at least: a first display element and a second display element; an optical element that transmits first display light emitted from the first display element and reflects second display light emitted from the second display element to form superimposed display light; and a light guide optical system that guides the superimposed display light to an eyeball, and the light guide optical system may be configured to form an intermediate image at least once on an optical path between the eyeball and each display element.

The display device module may be configured as described in the above 2. For example, the description regarding the first display element, the second display element, the optical element, and the light guide optical system in the above 2 also applies to the present embodiment. Furthermore, the description regarding the other components in the above 2 also applies to the present embodiment.

The present technology may also employ the following configurations.

[1]

A display device including at least:
a first display element and a second display element;
an optical element that transmits first display light emitted from the first display element and reflects second display light emitted from the second display element to form superimposed display light; and
a light guide optical system that guides the superimposed display light to an eyeball, in which
the light guide optical system is configured to form an intermediate image at least once on an optical path between the eyeball and each of the display elements.
   [2]

The display device according to [1], configured to make either or both of a position of a virtual image plane formed by the first display light and a position of a virtual image plane formed by the second display light shiftable.

[3]

The display device according to [2], in which
at least one of the first display element or the second display element is configured to be shiftable in an optical axis direction and
is configured to shift the position of the virtual image plane formed by each ray of display light in response to a shift in the optical axis direction.
   [4]

The display device according to any one of [1] to [3], in which
two sets of display device modules each including the first display element, the second display element, the optical element, and the light guide optical system are provided, and
one of the two sets of display device modules is configured to cause the superimposed display light to reach a left eye, and the other of the two sets of display device modules is configured to cause the superimposed display light to reach the left eye.
   [5]

The display device according to any one of [1] to [4], configured to present, using two or more rays of display light, one image higher in resolution than each ray of display light.

[6]

The display device according to any one of [1] to [5], further including a reflective element that reflects the superimposed display light to cause the superimposed display light to travel toward the eyeball.

[7]

The display device according to [6], in which the optical element and the reflective element are arranged so as to make a virtual image distance distribution in an observation plane approximately symmetrical in a left-right direction.

[8]

The display device according to any one of [1] to [7], in which the first display element is arranged so as to cause a display surface of the first display element to tilt relative to a plane orthogonal to an optical axis of the first display light.

[9]

The display device according to any one of [1] to [8], in which an antireflection film is provided on a surface on which the first display light emitted from the first display element impinges, of two surfaces of the optical element.

[10]

The display device according to any one of [1] to [9], in which a metal film is provided on a surface on which the second display light emitted from the second display element impinges, of two surfaces of the optical element.

[11]

The display device according to any one of [1] to [10], in which no optical component is arranged at or near a position where the intermediate image is formed.

[12]

The display device according to any one of [1] to [11], in which
the light guide optical system includes a lens optical system arranged on an optical path between the first display element and the optical element and a lens optical system arranged on an optical path between the second display element and the optical element, and
the two lens optical systems have the same configuration.
   [13]

The display device according to any one of [1] to [12], configured to correct an image displayed by each of the display elements in accordance with two or more rays of display light to be superimposed.

[14]

The display device according to any one of [1] to [13], further including a reflective element that reflects the superimposed display light to cause the superimposed display light to travel toward the eyeball, the reflective element being configured not to transmit light.

[15]

The display device according to any one of [1] to [14], configured as a stationary display device.

[16]

The display device according to any one of [1] to [15], in which a display surface of the first display element and a display surface of the second display element each have a diagonal dimension of 5 inches or less.

[17]

The display device according to any one of [1] to [16], having a viewing angle of 70° or more.

[18]

The display device according to any one of [1] to [17], having an image magnification of 1.5 times or more.

[19]

A display device module including at least:
a first display element and a second display element;
an optical element that transmits first display light emitted from the first display element and reflects second display light emitted from the second display element to form superimposed display light; and
a light guide optical system that guides the superimposed display light to an eyeball, in which
the light guide optical system is configured to form an intermediate image at least once on an optical path between the eyeball and each of the display elements.

Although the embodiments and examples of the present disclosure have been specifically described above, the present disclosure is not limited to the above-described embodiments and examples, and various modifications based on the technical idea of the present disclosure are possible.

For example, the configurations, the methods, the steps, the shapes, the materials, the numerical values, and the like described in the embodiments and examples described above are merely examples, and different configurations, methods, steps, shapes, materials, numerical values, and the like may be used as needed. Furthermore, the configurations, the methods, the steps, the shapes, the materials, the numerical values, and the like of the above-described embodiments and examples can be combined with each other without departing from the gist of the present disclosure.

Furthermore, in the present specification, a numerical range indicated by using “to” indicates a range including numerical values described before and after “to” as the minimum value and the maximum value, respectively. In the numerical ranges described in stages in the present specification, the upper limit value or the lower limit value of a numerical range of a certain stage may be replaced with the upper limit value or the lower limit value of a numerical range of another stage.

### REFERENCE SIGNS LIST

10, 100 Display device
11, 101 First display element
12, 102 Second display element
13, 103 Optical element
14, 109 Light guide optical system

1. A display device comprising at least:
a first display element and a second display element;
an optical element that transmits first display light emitted from the first display element and reflects second display light emitted from the second display element to form superimposed display light; and
a light guide optical system that guides the superimposed display light to an eyeball, wherein
the light guide optical system is configured to form an intermediate image at least once on an optical path between the eyeball and each of the display elements.

2. The display device according to claim 1, configured to make either or both of a position of a virtual image plane formed by the first display light and a position of a virtual image plane formed by the second display light shiftable.

3. The display device according to claim 2, wherein
at least one of the first display element or the second display element is configured to be shiftable in an optical axis direction and
is configured to shift the position of the virtual image plane formed by each ray of display light in response to a shift in the optical axis direction.

4. The display device according to claim 1, wherein
two sets of display device modules each including the first display element, the second display element, the optical element, and the light guide optical system are provided, and
one of the two sets of display device modules is configured to cause the superimposed display light to reach a left eye, and another of the two sets of display device modules is configured to cause the superimposed display light to reach the left eye.

5. The display device according to claim 1, configured to present, using two or more rays of display light, one image higher in resolution than each ray of display light.

6. The display device according to claim 1, further comprising a reflective element that reflects the superimposed display light to cause the superimposed display light to travel toward the eyeball.

7. The display device according to claim 6, wherein the optical element and the reflective element are arranged so as to make a virtual image distance distribution in an observation plane approximately symmetrical in a left-right direction.

8. The display device according to claim 1, wherein the first display element is arranged so as to cause a display surface of the first display element to tilt relative to a plane orthogonal to an optical axis of the first display light.

9. The display device according to claim 1, wherein an antireflection film is provided on a surface on which the first display light emitted from the first display element impinges, of two surfaces of the optical element.

10. The display device according to claim 1, wherein a metal film is provided on a surface on which the second display light emitted from the second display element impinges, of two surfaces of the optical element.

11. The display device according to claim 1, wherein no optical component is arranged at or near a position where the intermediate image is formed.

12. The display device according to claim 1, wherein
the light guide optical system includes a lens optical system arranged on an optical path between the first display element and the optical element and a lens optical system arranged on an optical path between the second display element and the optical element, and
the two lens optical systems have a same configuration.

13. The display device according to claim 1, configured to correct an image displayed by each of the display elements in accordance with two or more rays of display light to be superimposed.

14. The display device according to claim 1, further comprising a reflective element that reflects the superimposed display light to cause the superimposed display light to travel toward the eyeball, the reflective element being configured not to transmit light.

15. The display device according to claim 1, configured as a stationary display device.

16. The display device according to claim 1, wherein a display surface of the first display element and a display surface of the second display element each have a diagonal dimension of 5 inches or less.

17. The display device according to claim 1, having a viewing angle of 70° or more.

18. The display device according to claim 1, having an image magnification of 1.5 times or more.

19. A display device module comprising at least:
a first display element and a second display element;
an optical element that transmits first display light emitted from the first display element and reflects second display light emitted from the second display element to form superimposed display light; and
a light guide optical system that guides the superimposed display light to an eyeball, wherein
the light guide optical system is configured to form an intermediate image at least once on an optical path between the eyeball and each of the display elements.
